(19) United States
(12) Patent Application Publication
(10) Pub. No.: US 2006/0007151 A1
(43) Pub. Date: Jan. 12, 2006

(54) Computer Apparatus with added functionality

(75) Inventor: Pranil Ram, Makati City (PH)

Correspondence Address: MR. PRANIL RAM;c/o MR. SUNIL RAM, 6390 WILLINGDON AVE, APT. 313, BURNABY, BC, V5H2V5, CA

(73) Assignee: Pranil Ram, Makati City (PH)

(21) Appl. No.: 11/160,090

(22) Filed: Jun. 8, 2005

Related U.S. Application Data
(60) Provisional application No. 60/577,593, filed on Jun. 8, 2004.

(51) Int. Cl. G09G 5/08

(52) U.S. Cl. 345/163

(57) ABSTRACT

A computer apparatus such as a mouse, keyboard, or PC headset with additional devices disposed within the apparatus enclosure, which can enhance the functionality of such computer apparatus. In the preferred embodiment, the additional devices are disposed within or along the length of a mouse apparatus. The additional devices typically function independently of the mouse apparatus. However, the additional components may share one or more wired or wireless paths to a host PC and to other devices, or to a network. The additional devices either integrated within the mouse enclosure or removable from the mouse enclosure, include a wireless adapter (Wi-Fi, Bluetooth, 3G, GSM, etc. . . . ), RAM, ROM, a mini hard drive, a GPS receiver module, a flash memory, flash memory drive reader, a USB Hub, a Trackpoint™ device, a keyboard or keypad, a fingerprint reader, or a SIM card reader. Also disclosed, are software controls for mapping the mouse velocity to a cursor velocity and for controlling the function and settings of the Trackpoint device. Further disclosed is a method for assigning the mouse's data output to a variety of devices connected to a wired or wireless network.

### CROSS-REFERENCE TO RELATED APPLICATIONS

This application claims priority to the following U.S. Provisional Patent Application Ser. No. 60/577,593 entitled “COMPUTER APPARATUS WITH ADDED FUNCTIONALITY,” filed Jun. 8, 2004; The contents of all the above are incorporated herein by reference.

### FIELD OF THE INVENTION

This invention relates generally to computer peripherals such as a computer mouse or keyboard, and more particularly, to incorporating additional devices or functionality within such computer peripherals.

### BACKGROUND

The computer mouse has become an essential component of desktop computing since graphical user interface was popularized in the 1980s with the introduction of the Apple Macintosh.

In the succeeding 20 years, the computer mouse has undergone a series of innovations including the addition of a right- and left-click button, a mousewheel, an optical sensor, a track ball sensor, a laser sensor, and wireless communication to the host PC.

To fit comfortably into the hand, a mouse requires an ergonomic shape which is one factor that has kept its size relatively stable. However, the internal electronics of the mouse follows a trend to become miniaturized with many circuits integrated within a single chip, perhaps in an attempt by manufacturers to reduce costs as well as size. Computer peripherals are often distributed as stand alone products, and the cost of manufacturing and distribution to retailers is a significant portion of the retail cost.

There is room within a typical mouse enclosure, as well as the enclosures of other peripheral devices, for more added functionality. With so many stand alone devices connected to a host PC, there is a need to combine devices within a single device or apparatus for reasons of economy, practicality, and convenience. Thus, it is an objective of the present Invention to combine one or more additional devices within a mouse apparatus, or a related computer peripheral such as a keyboard, to obtain additional functionality and convenience for the user without the need to carry multiple stand alone products that add clutter and bulk.

### BRIEF SUMMARY OF THE INVENTION

The mouse apparatus of the present invention may be used by travelers who desire convenience and may also be given out in hotels, restaurants, parks, bars, and other public hotspots to allow patrons to access a wireless network.

The present invention provides an optical computer mouse with an embedded wireless adapter connected to its host PC by a USB connector. A USB hub or hub/bridge is also embedded within the mouse enclosure to allow the wireless adapter to share the single USB connection to the host PC.

A Trackpoint device or a Trackball may be incorporated into the mouse enclosure to function as a cursor-pointing device and/or a window scroll-control device. The trackball device serves as the mouse's motion sensor and is used for cursor-pointing function.

The computer mouse may be configured as a wired or wireless device. In a wired configuration, any wireless communications adapter may serve to add wireless capability to the host PC or a network device. In a wireless configuration, the wireless communications adapter serves to enable the devices embedded within the mouse enclosure to communicate with and support the host PC or a network device.

RAM memory and/or a flash memory card reader may also be incorporated into either the base USB connector unit or the mouse enclosure. There is no need to install a separate wireless network adapter to the host PC. The wireless or Wi-Fi adapter is built-in into the mouse apparatus.

The computer mouse apparatus also discloses how multiple devices, commonly purchased by computer users, may share a common mouse enclosure thus reducing manufacturing, packaging, and distribution costs relative to individually packaged USB or PC Card devices.

In accordance with another aspect of the present invention, a computer mouse may serve as a network mouse attached to a host PC or computer device via a USB connection or similar cable connection, and a multiple port USB hub device may be embedded within the mouse enclosure and serves to network the embedded devices to the host PC. The computer mouse may be configured to function as a wired or wireless network mouse. The mouse can have a network connection that can access or provide input to a number of target devices connected to the network, not just the host PC.

In accordance with a further aspect of the present invention, a computer mouse may also contain one or more of the following devices, which may be integrated or removable from the mouse enclosure: a USB or network hub, a connector , a module, a modem, a sensor, an on/off switch, a temperature sensor, a USB on-the-go bridge controller device, an encryption chip or hardware, a digital signal processing device, a modem circuitry, a display device, a digital camera, a web cam, CPU and the like. Such devices may function individually and/or in combination with the other devices, sensors, and electronics to add to or enhance the function of the computer mouse apparatus. The additional components may share one or more wired or wireless paths to a host PC and to other devices, or to a network.

In accordance with an additional aspect of the present invention, a CPU and its associated chipsets or a system-on-a-chip device may be utilized within the computer mouse apparatus. Such a CPU or system chip may serve to manage computer processing tasks within the mouse enclosure rather than relying solely on the host PC's processing power. Such a mouse apparatus may run a proprietary OS, a Palm OS 3, 4 or 5, Pocket PC, SmartPhone, PalmSource, Symbian, Java, Microsoft, and Linux operating systems or any desktop O/S such as Windows XP. A built-in CPU or system chip would enable the mouse electronics and the remaining embedded devices to function as a small self-contained computer.

In accordance with yet another aspect of the present invention, the mouse apparatus may incorporate USB host capability that may store data to or retrieve data from the memory card utilizing the computer mouse's built-in wireless communications module.

The computer mouse apparatus of the present invention is environmentally friendly as it reduces the manufacturing, packaging, and distribution costs of multiple discrete devices manufactured or sold as separate discrete devices.

Also disclosed, are software controls for mapping the mouse velocity to a cursor velocity and for controlling the function and settings of the Trackpoint device. Further disclosed is a method for assigning the mouse's data output to a variety of devices connected to a wired or wireless network.

The foregoing summary of the present invention is not intended to describe every implementation of the present invention. Additional aspects and advantages of the invention will be readily apparent from the following detailed description of preferred embodiments thereof, which proceeds with references to the accompanying drawings.

### BRIEF DESCRIPTION OF THE DRAWINGS

FIG. 1 illustrates a top view of a computer mouse apparatus incorporating a Trackpoint™ device.

FIG. 2 illustrates a top view of a computer mouse apparatus with a Trackpoint sensor in an alternative location to that shown in FIG. 1.

FIG. 3 illustrates a side view of the computer mouse apparatus as shown in FIG. 1.

FIG. 4 illustrates a front view of the computer mouse apparatus as shown in FIG. 1.

FIG. 5 illustrates a top view of a computer mouse apparatus with a Trackpoint sensor and a mouse scroll wheel.

FIG. 6 illustrates a top view of a cordless computer mouse apparatus with a mouse scroll wheel and a Trackpoint device in an alternative arrangement to that of FIG. 5.

FIG. 7 illustrates a top view of a computer mouse apparatus with two Trackpoint devices, a button, and a flash memory reader slot.

FIG. 8 illustrates a top view of a computer mouse apparatus with a Trackpoint sensor and a built-in wireless communication adapter module with an internal antenna.

FIG. 9 illustrates a front view of a computer mouse apparatus with a mouse scroll wheel control, a USB plug, a USB jack, and a built in Wi-Fi adapter module with its associated external antenna.

FIG. 10 illustrates a side view of the computer mouse apparatus as shown in FIG. 8.

FIG. 11 illustrates a perspective view of a wireless computer mouse apparatus with a Trackpoint device and an associated base unit having an integrated wireless communications adapter module and an internal antenna.

FIG. 12 illustrates a perspective view of a wired computer mouse apparatus with an embedded Trackpoint device and an in-line electronics housing and connection unit which incorporates an integrated wireless network adapter module and an external antenna.

FIG. 13 illustrates a top view of a computer mouse apparatus with a Trackpoint sensor and an internal group of peripheral devices which include a mini hard drive, a wireless adapter module, flash (RAM or ROM) memory, and a flash memory card reader.

FIG. 14 illustrates a top view of a computer mouse apparatus with a Touchpad cursor-pointing and/or scrolling device, and internal peripherals which include a mini hard drive, flash memory, and a flash memory card reader.

FIG. 15 illustrates a top view of a computer mouse apparatus with a 5-way navigation button.

FIG. 16 illustrates a block diagram of the representative system architecture for the computer mouse apparatus depicted in FIGS. 8 to 15, and FIGS. 17 to 25.

FIG. 17 illustrates a top view of a computer mouse apparatus with a Trackpoint sensor, a display, a flash memory card slot or SIM card reader, and a digital camera or webcam.

FIG. 18 illustrates a top view of a computer mouse apparatus with a Trackball cursor-pointing and window scrolling device, a display, a SIM card reader or flash memory card reader, and a digital camera or webcam.

FIG. 19 illustrates a side view of the computer mouse apparatus as shown in FIG. 17 with an integrated speaker or microphone element, a network connector, and a hinged display enclosure.

FIG. 20 illustrates a top view of a computer mouse apparatus with a Trackpoint cursor-pointing and window scrolling sensor, a display, a flash memory card slot, a digital camera, a number keypad or keyboard, and an optional recharging unit.

FIG. 21 illustrates a side view of the computer mouse apparatus as depicted in FIG. 20, showing a representation of a printed circuit board, a flash memory card slot, and a hinged display assembly.

FIG. 22 illustrates a top view of a computer mouse apparatus with a mouse scroll wheel device, a display, a flash memory card slot, and a digital camera.

FIG. 23 illustrates a top view of a computer mouse apparatus with a 5-way navigation button, a display, a flash memory slot, a digital camera, and a numerical keypad or keyboard.

FIG. 24 illustrates a top view of a computer mouse apparatus with a Trackpoint sensor, a display, a flash memory card slot, a digital camera, a biometric fingerprint scanner, and an ID card or SIM card slot.

FIG. 25 illustrates a top view of a computer mouse apparatus with a Touchpad cursor-pointing and/or window scrolling device, a display, a flash memory card slot, a webcam camera, and a group of keys which are representative of function keys, a numerical keypad, or a keyboard.

FIG. 26 is a block diagram of a simplified USB hub integrated in the computer mouse apparatus.

FIG. 27 shows a simplified block diagram of an 802.11 networking chipset; the host interface implements functions that allow the chipset to interface with a host system such as a computer.

FIG. 28 shows a system block diagram of a wireless computer mouse apparatus with an integrated USB OTG bridge controller and USB hub chip, mouse electronics, a wireless communications adapter, and several embedded devices.

FIG. 29 illustrates a perspective view of a USB-based PC headset apparatus with added device functionality.

FIG. 30 illustrates a top view of a wired keyboard apparatus with added device functionality.

FIG. 31 shows a representative display of a Properties Settings dialog box suitable for the mouse apparatus depicted in FIGS. 8 to 15 and FIGS. 17 to 25.

FIG. 32 illustrates a perspective view of a computer mouse apparatus, its enclosure door in an open position to show a mouse cavity with an integrated USB jack; a USB connector that is fixedly attached to a USB plug is also shown beside the mouse apparatus.

FIG. 33 illustrates a perspective view of a computer mouse apparatus as shown in FIG. 32, with the USB module connected into the USB jack via its associated USB plug.

FIG. 34 illustrates a perspective view of a computer mouse apparatus, similar to that shown in FIGS. 32-33, its enclosure cover in an open position to show two module jacks of different sizes; associated module plugs that are fixedly attached to their respective modules are also shown beside the mouse apparatus.

FIG. 35 illustrates a perspective view of a wireless computer mouse apparatus with an integrated PCMCIA slot; a PCMCIA module that is fixedly attached to a PCMCIA connector is also shown beside the mouse apparatus.

FIG. 36 illustrates a perspective view of a wireless computer mouse apparatus as shown in FIG. 35, with the PCMCIA module connected into the PCMCIA slot via the PCMCIA connector.

FIG. 37 illustrates a perspective view of a wireless computer mouse apparatus with an integrated USB jack, and a spring-loaded cover; a USB module that is fixedly attached to a USB plug is also shown beside the mouse apparatus.

FIG. 38 illustrates a perspective view of a wireless computer mouse apparatus as shown in FIG. 37, with the USB module connected into USB jack via the USB plug.

FIG. 39 shows a computer mouse apparatus incorporating a gas sensor unit and its associated electronics.

FIG. 40 shows a computer mouse apparatus incorporating a dual cursor pointing device.

FIG. 41 shows a computer mouse apparatus on the top of a companion solar panel or array of solar cells disposed within a mousepad.

FIG. 42 shows a computer mouse apparatus powered by solar energy.

FIG. 43 shows a computer mouse apparatus with an integrated optical drive disposed within the mouse enclosure, and accessible through the enclosure cover.

FIGS. 44a-44b are simplified partial cross sectional views of a computer mouse apparatus taken along lines 44-44 of FIG. 1 showing a molded pressure absorbing spring which functions to reduce the stress on a miniature switch caused by clicking of the mouse button by a user.

FIGS. 45a-45b illustrate a fixedly attached pressure absorbing leaf spring, a variation of the spring design as shown in FIGS. 44a-44b.

FIGS. 46a-46b illustrate a pressure absorbing compression spring, a variation of the spring designs as shown in FIGS. 44a-45b.

FIG. 47 shows a cursor velocity tabpage, which is used to control the relationship between the velocity of the mouse movement and the velocity of the displayed cursor associated with the mouse movement.

FIG. 48 shows a simple flowchart process to control cursor velocity.

FIGS. 49-50 show in detail the operation of the two-dimensional graph of FIG. 47.

FIG. 51 shows a computer apparatus architecture typically associated with the mouse apparatus of FIGS. 17-25 in accordance with an embodiment of the present invention.

FIG. 52 shows one use of a mouse apparatus with added functionality in a PABX branch exchange telephone system located within an office environment.

FIGS. 53a and 53b show a partial view of a network mouse apparatus assigned to input data to a specific device.

FIG. 54 illustrates a typical operating environment for a network mouse apparatus.

FIG. 55 shows a Trackpoint settings tabpage associated with a Trackpoint device if present on a mouse apparatus.

FIG. 56 illustrates a sensor function tabpage.

FIG. 57 illustrates a top view of a cantilevered printed circuit board (PCB), a variation of the pressure absorbing spring designs as shown in FIGS. 44a-46b.

FIG. 58 is a cross sectional view of the mouse apparatus as shown in FIG. 57 and a variation of the cross sectional views of FIGS. 44a-46b.

FIGS. 59a-59b show back views of a mouse apparatus with a built-in charger unit and a retractable wall plug at its bottom side.

FIG. 60 shows a mouse apparatus architecture when the additional device is in a RAID system of mini hard drives.

### DETAILED DESCRIPTION OF INVENTION

The present invention discloses a computer mouse apparatus with an integrated Trackpoint™ device or a similar device which functions both as a cursor-pointing device or a scroll control device. The Trackpoint device may control both cursor and scroll movements in four directions: left, right, up, and down. As a scroll control device, the Trackpoint device may replace the mouse wheel mechanism common to computer mouse devices. As a cursor-pointing device, the Trackpoint device may function in conjunction with the optical motion sensor typically located at the bottom of computer mouse devices or it may replace the function of the optical motion sensor. The Trackpoint device used in the present invention may function similarly to any generic Trackpoint device available and not necessarily the Trackpoint device manufactured and used by IBM in its computers.

The present invention also discloses how multiple devices may share a common mouse enclosure, which may drastically reduce manufacturing, packaging, and distribution costs relative to individually packaged USB or PC card (PCMCIA slot) devices such as flash memory sticks, GPS receivers, mini hard drives, Wi-Fi adapters, and network hubs. Such use of a mouse enclosure saves on the overall costs since multiple separate devices commonly purchased by computer users can be integrated or built-in, that is, in the mouse enclosure. With the present invention, there is no need to install a separate wireless network adapter PCI card or PCMCIA card or standalone USB wireless adapter to the host PC. The wireless or Wi-Fi adapter is built-in into the computer mouse or keyboard.

In the present invention, USB-based devices can have embedded or removable memory in the keyboard or mouse to store, backup, update, and synchronize data files. For example, a RAM in the mouse with USB or wireless connection may be adapted as a convenient backup device to store data files. A flash memory reader or flash memory incorporated within a mouse may have 32-1024 Megs of memory for back-up and data portability. This approach enables the user to take a wireless adapter and mouse with a laptop to access additional devices without a lot of tangled cords or the inconvenience of attaching separate devices one at a time. Generally, connection to all devices will be thru a common USB cable.

The computer mouse apparatus may be used by travelers who desire convenience and may also be made available in hotels, restaurants, parks, bars, and other public hotspots to allow patrons to access a wireless network.

The preferred embodiment of the present invention is an optical computer mouse with an embedded wireless adapter and with the computer mouse connected to its host PC by a USB connector. A USB hub or hub/bridge is also embedded within the mouse enclosure to allow the wireless adapter to share a single USB connection to the host PC. A Trackpoint device may be incorporated into the mouse enclosure to function as a cursor-pointing device and/or a window scroll control device. RAM memory and/or a flash memory card reader may also be incorporated into the mouse enclosure or the USB connector. The computer mouse apparatus, as a wireless device, incorporates the wireless adapter, memory, and memory card reader in either the base USB connector unit or the mouse enclosure.

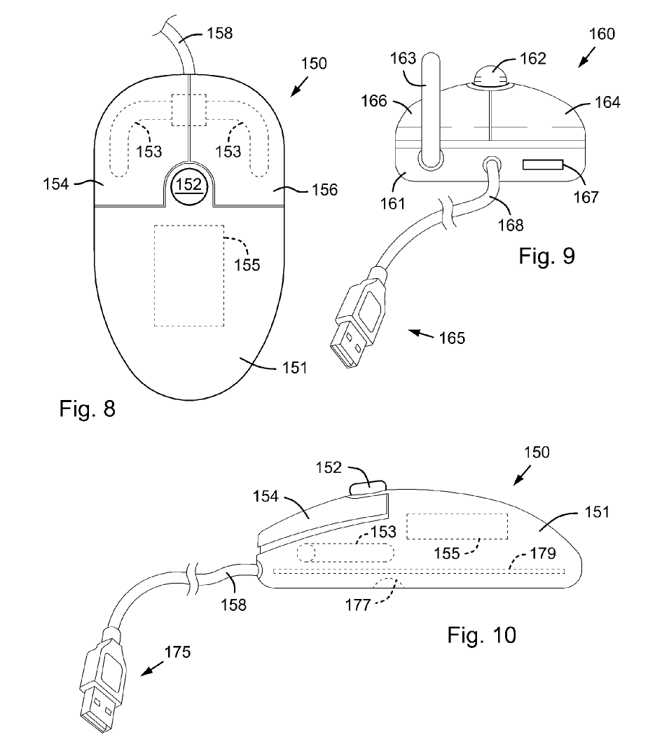

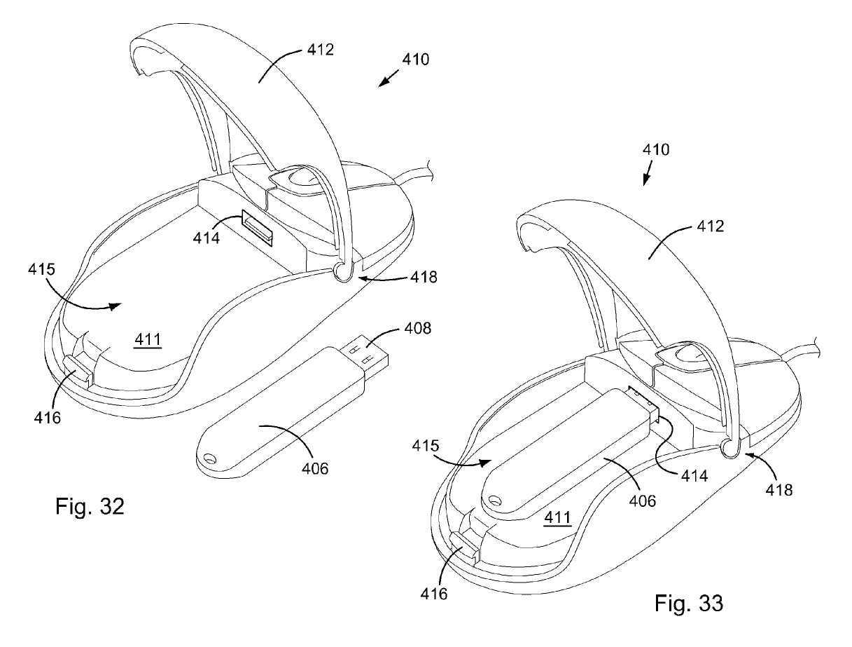

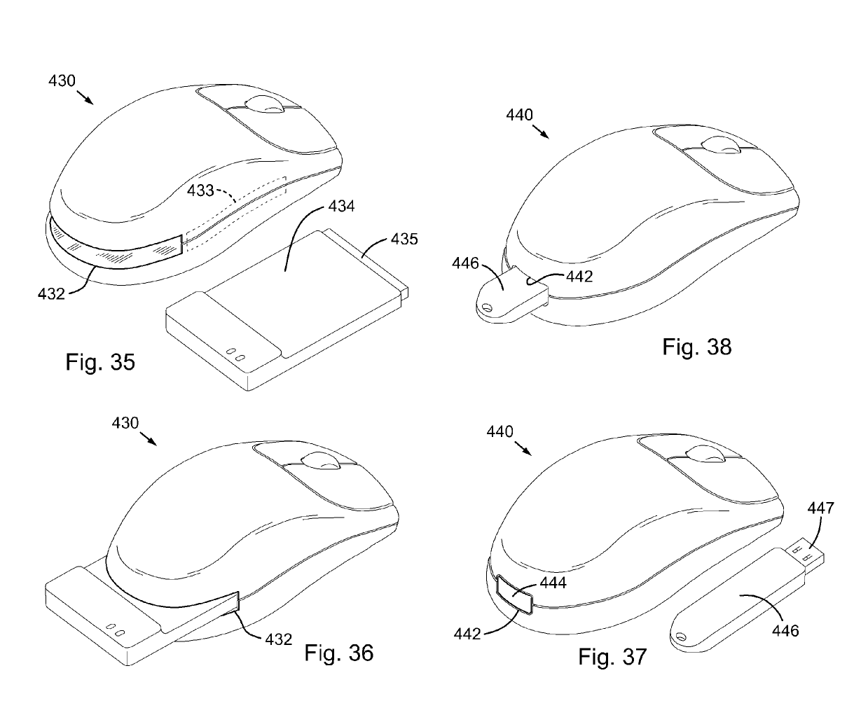

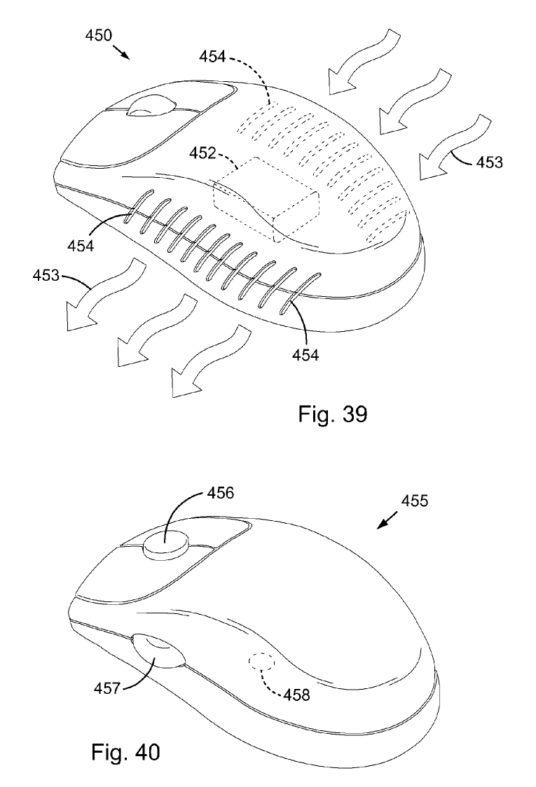

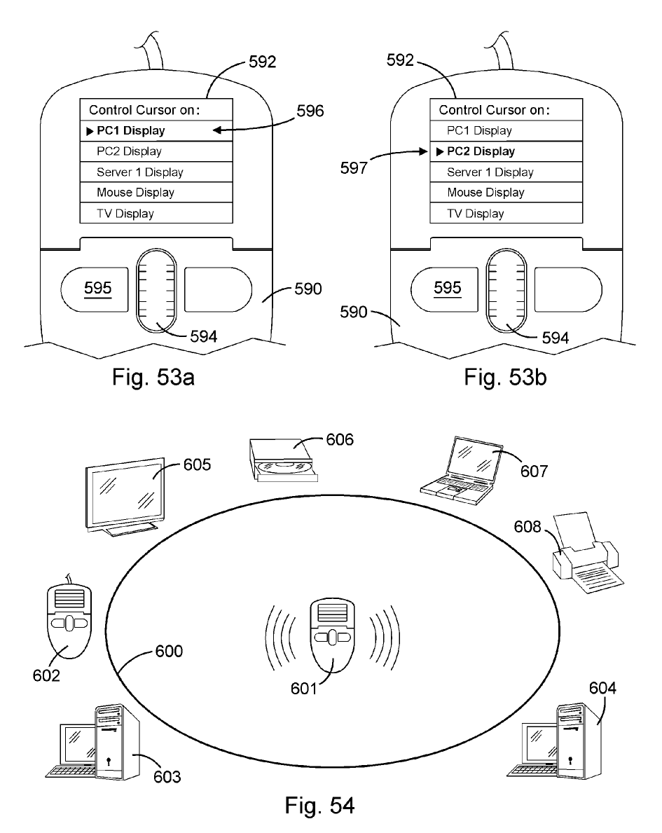

It should be understood that the preferred embodiment of the present invention and the additional functionality as described and shown in the drawings may also be incorporated within a Keyboard Apparatus, a PC Speaker Apparatus, a PC Headset Apparatus, and similar devices. For example, the gas sensor of FIG. 39 may be similarly integrated into a Keyboard Apparatus, as may be the solar panel as depicted in FIG. 42, the PMCIA slot of FIGS. 35-36, the flash drive as shown in FIGS. 37-38, the modules associated with FIGS. 32-34, the device assignments control of FIG. 53, the various architecture embodiments as shown in FIGS. 16, 26-28, 51, the Wi-Fi adapter as shown in FIGS. 8-9, and the like.

Although most of the figure drawings of the present invention display additional functionality related to a computer mouse apparatus, such additional functionality may be similarly integrated into a Keyboard Apparatus, and other similar computer devices, as previously mentioned.

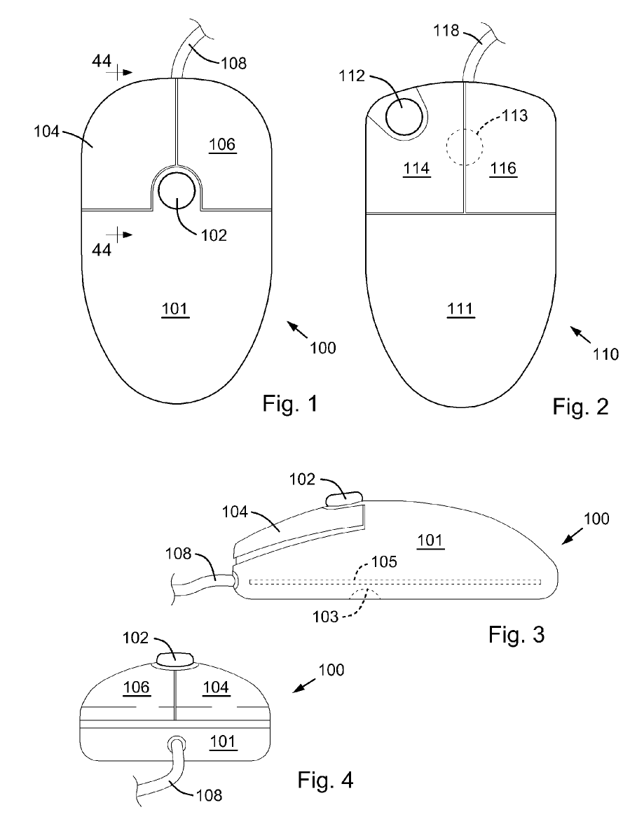

Turning now to FIG. 1.

FIG. 1 illustrates a top view of a PC compatible computer mouse apparatus 100 with an integrated Trackpoint device 102. The Trackpoint device 102, with its associated hardware and software components, functions as a cursor-pointing device or a window scrolling device.

Also shown are a left-click button 104, a right-click button 106, a wired connection 108 to a host PC, PDA, Tablet PC, or mouse-enabled device. The buttons 104,106 and Trackpoint device 102 are all embedded within the mouse enclosure 101.

The Trackpoint device 102 consists of a finger pad visible on the surface of the mouse enclosure 101, and four (4) strain gauges embedded within the mouse apparatus 100, which serve as directional pressure sensitive sensors similar in function to the IBM Trackpoint device typically found on the keyboards of IBM branded laptop computers.

Movement of the cursor-pointer on the display screen is controlled by the amount of pressure the user applies to the non-slip Trackpoint finger pad in any direction parallel to the mouse enclosure 101. The speed at which the cursor-pointer moves, or the window contents scroll, corresponds to the pressure applied by the user to the finger pad. Pointing, selecting, and dragging with the Trackpoint sensor are part of a single process that can be performed without the user moving his or her fingers away from the Trackpoint finger pad.

The Trackpoint device 102 may function as a cursor-pointing device to complement the cursor-pointing function of the optical motion sensor 103 (shown in FIG. 3) located at the bottom of the mouse enclosure 101. The Trackpoint device 102 may also function as a window scrolling control device similar to the function of a mouse wheel in a conventional PC mouse. The Trackpoint device's function is chosen by adjusting the mouse configuration settings. A button located on the mouse enclosure 101 may also toggle between the Trackpoint device's two functions.

The smooth functioning of the Trackpoint device 102 is supported by a software control algorithm so users can move the cursor, select icons or texts, and scroll software contents within a window in a quick, accurate, and comfortable manner.

The Trackpoint device 102 and its associated circuitry and software may be configured as a cursor-pointing device or as a window content scroll control device. The Trackpoint device 102 may be based on any sensor capable of sensing force or pressure applied by the user (typically using fingertip pressure) in the four directions (left, right, up, and down) representative of movement on the display screen. The Trackpoint device 102 may also enable the use of buttons, left-clicks, right-clicks, and double-clicks of the types used in window-based graphical user interfaces.

The Trackpoint device 102 may also incorporate control software and/or additional sensors to control the display cursor movement or the window scroll direction of a 3D display and its associated graphical user interface.

FIG. 2 is a variation of the computer mouse apparatus as illustrated in FIG. 1.

FIG. 2 illustrates a top view of a computer mouse apparatus 110 with a Trackpoint sensor 112 in location alternative to that shown in FIG. 1. The alternative location of Trackpoint device 112 permits the index fingertip of a right-handed user to easily reach the sensor. Another Trackpoint device alternative location 113 is also shown at middle of left-click button 114 and right-click button 116.

Also shown are a left-click button 114, a right-click button 116, a wired connection 118 to a host PC, PDA, or mouse-enabled device. The buttons 114, 116 and Trackpoint device 112 are all embedded within the mouse enclosure 111.

FIG. 3 illustrates a side view of the computer mouse apparatus 100 illustrated in FIG. 1.

Electronic components for the Trackpoint device 102 and the remaining mouse electronics are located on a printed circuit board (PCB) 105 within mouse enclosure 101. Also shown is a bottom motion sensor area 103 typically associated with an optical or mechanical mouse.

FIG. 4 illustrates a front view of the computer mouse 100 as depicted in FIG. 1. It shows Trackpoint device 102, a left-click button 104, a right-click button 106, and a wired connection 108 to a host PC, PDA, or a related computer device. The buttons 104,106 and Trackpoint device 102 are embedded within the mouse enclosure 101.

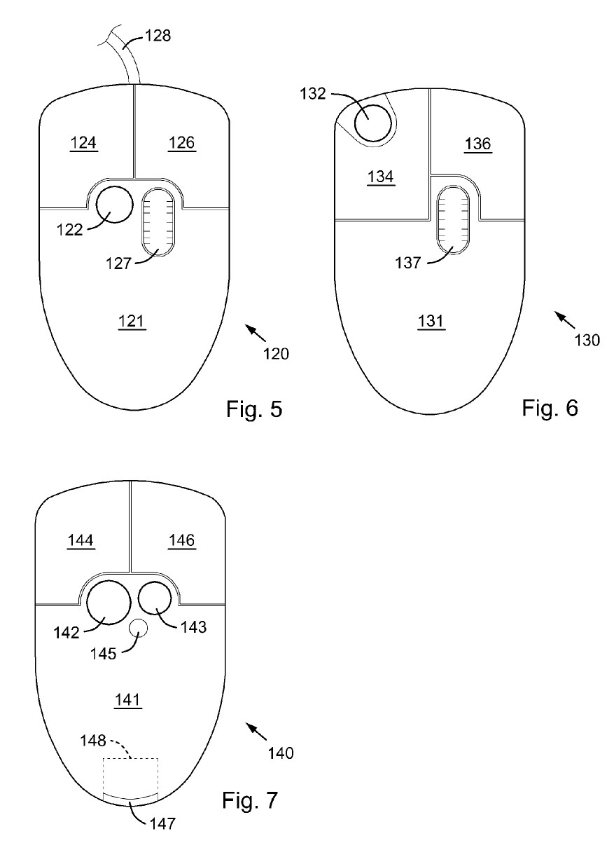

FIG. 5 is a variation of the computer mouse apparatus as illustrated in FIG. 1.

FIG. 5 illustrates a top view of a computer mouse 120 with a Trackpoint sensor 122 and a mouse scroll wheel 127. Also shown are a left-click button 124, a right-click button 126, a wired connection 128 to a host PC, PDA, or mouse-enabled device. The buttons 124,126 and Trackpoint sensor 122 are embedded within a mouse enclosure 121.

The Trackpoint device 122 and the mouse scroll wheel 127 may be programmed to serve different functions. For example, the left Trackpoint sensor 122 may be programmed to scroll the contents of the active window left, right, up, and down. The mouse scroll wheel 127 may be programmed for a program application specific tasks such as rotating an image in Adobe Photoshop or zooming in or zooming out of an object in a CAD/CAM program.

FIG. 6 is a variation of the computer mouse apparatus as illustrated in FIG. 5.

FIG. 6 illustrates a top view of a cordless computer mouse 130 with a mouse scroll wheel 137 and a Trackpoint device 132 in an arrangement alternative to that of. FIG. 5.

Also shown are a left-click button 134 and a right-click button 136. The buttons 134, 136 and Trackpoint device 132 are all embedded within a mouse enclosure 131.

The mouse electronics includes a wireless connection to a host PC, PDA, or mouse-enabled device via a wireless communications technology. Such a technology may be proprietary or an industry standard such as Bluetooth, Wi-Fi, WiMax, or an optical IR infrared port.

FIG. 7 is a variation of the computer mouse apparatus as illustrated in FIG. 6.

FIG. 7 illustrates a top view of a cordless computer mouse apparatus 140 with two Trackpoint devices 142,143, a function button 145, and a flash memory card reader slot 147. The memory card is inserted into the card slot 147 and rests within the memory card housing 148 until it is removed by the user.

Also shown are a left-click button 144 and a right-click button 146. The buttons 144, 146 and Trackpoint devices 142,143 are all embedded within the mouse electronics housing 141. The two Trackpoint devices 142, 143 may be programmed to serve different functions. For example, the left Trackpoint device 142 may be programmed to scroll the contents of the active window left, right, up, and down. The right Trackpoint device 143 may be programmed for a program application specific tasks such as selecting a range of cells in Microsoft Excel, selecting a range of text in a Microsoft Word document, or moving the object nearest the cursor left, right, up, or down.

Removable digital memory products include memory card products such as Secure Digital (SD), mini SD, multimedia cards (MMC), compact flash and other flash memory products. Removable memory devices are typically utilized in digital cameras, mobile phones, music players and other consumer electronics that use the removable memory cards to store and transport data. Memory cards come in postage-stamp and matchbook sizes and currently use flash memory. However, other memory technologies such as magnetic random access memory (MRAM) are in development. MRAM will be able to store a substantial amount of data, consume little energy, and operate faster than conventional flash memory. The computer mouse apparatus of the present invention anticipates the use of this type of memory technology. Also becoming increasing popularly as a mass storage media for devices such as digital cameras, camcorders, and USB sticks, are non-volatile flash memories. The most advanced nonvolatile flash memory devices available today can permanently store one or two bits of information per memory cell without a supply voltage. Such memories have a feature size of around 90 nanometers, and shrinking this feature size using typical techniques to half that size has posed many problems because of nanoscale physical effects. The largest flash memory chips currently available exceed 1 GB and as costs drop, such devices may be incorporated into more electronic devices.

FIG. 8 is a variation of the computer mouse apparatus as illustrated in FIG. 1.

FIG. 8 illustrates a top view of a computer mouse 150 incorporating a Trackpoint sensor 152 and a built-in Wireless communications adapter module 155 with an internal antenna 153.

Also shown are a left-click button 154, a right-click button 156, a wired connection 158 to a host PC, PDA, or mouse-enabled device. The buttons 154,156 and Trackpoint device 152 are all embedded within a mouse enclosure 151.

A module, as the term is used in the foregoing, refers to electronics circuitry designed to perform a specific function. Hence, a Wi-Fi module refers to electronics circuitry designed to transmit and receive a Wi-Fi signal and to communicate the processed input and output data to a secondary device or application on the host PC. Its electronics circuitry may require EMI shielding to prevent signals from the wireless adapter's internal or external antenna from disrupting the electronics of other devices within the mouse enclosure.

The wireless communications adapter module 155 enables the host PC to support and communicate in one or more wireless technologies such as Wi-Fi, Bluetooth, WiMax, 2G, 2.5G, 3G, GSM, TDMA, CDMA, PCS, GPRS, WAP, GPS, mesh networks, satellite radio & video, AM, FM, FRS, RFID, ZigBee, optical IR, and the like. The signals may be received from the cellular network or from nearby Wi-Fi, Wi Max, or Bluetooth hotspots.

Typically, the wireless adapter 155 includes support for Wi-Fi connectivity. Wi-Fi is also known as 802.11 in the IEEE standards and comes in a number of evolved variants such as 802.11a, 802.11b, 802.11g and the like. The range of the Wi-Fi signal is typically 75-300 feet. Handheld devices and other computers with wireless networking capability can access the host PC via the Wi-Fi adapter 155 embedded within the computer mouse apparatus 150. Intel manufactures chips that integrate the growing number of wireless technologies including Bluetooth, WiMax, and Wi-Fi, and permit detailed graphics on small devices.

A wireless adapter is used to establish a wireless network with other PCs and peripheral devices using at least one wireless standard. In order for the wireless communications module 155 to function as the wireless adapter for a host PC with no existing wireless communications ability, a wired connection 158 from the wireless adapter embedded in computer mouse apparatus 150 to the host PC or device is needed. This wired connection 158 may be based on any suitably supported connector type and data transfer standard. The various embodiments of a computer mouse with an integrated wireless adapter module will typically connect to its host PC via a single USB connector 175 (shown in FIG. 10). Any suitable connector style or data bus standard may be used such as USB 2.0/1.1, FireWire 400/800/1394a/1394b, serial, and parallel connectors.

USB 2.0 and FireWire 800 are both backward compatible. Hence, if the computer mouse apparatus 150 is attached to a system with only USB 1.1 or legacy FireWire 400/1394a ports, the embedded devices will still be able to function at the fastest possible speed available.

A button or switch can be incorporated within the mouse enclosure 151 which functions to toggle the wireless connection to an enabled or disabled state for added convenience and security. A multi-colored LED may also be incorporated within the mouse enclosure 151 which serves to indicate status information or whether or not wireless data is incoming or outgoing or both (green, red, or yellow LED indicator light respectively) via the built-in wireless adapter 155.

FIG. 9 is a variation of the computer mouse apparatus illustrated in FIG. 8.

FIG. 9 illustrates a front view of a computer mouse apparatus 160 with a mouse scroll wheel control 162, a USB plug 165, a USB jack or port 167, and a built-in wireless communications adapter module (not shown) with its associated external antenna 163. An external antenna 163 may be more suitable to wireless environments where antenna orientation, size, and obstruction are important considerations. The external antenna 163 may be pivoted to help aim in the right direction.

Also shown are a left-click button 164, a right-click button 166, a wired connection 168 to a host PC, PDA, or mouse-enabled device. The buttons 164,166, antenna 163, and Trackpoint device 162 are all embedded within a mouse enclosure 161.

Turning now to FIG. 10.

FIG. 10 illustrates a side view of the computer mouse apparatus 150 as illustrated in FIG. 8. The electronics of the mouse and the wireless communications adapter module 155 may be on a common PCB board 179 or on separate printed circuit boards.

If the Trackpoint device 152 is not enabled to control the position of the cursor on the host PC's display, then a separate motion sensor 177 is needed to serve the cursor-pointing function of the mouse. Typically, such cursor-pointing motion sensor 177 on a PC mouse are based on optical sensors or mechanical sensors to detect the motion of the mouse.

In the computer mouse apparatus of the present invention, it is expected that both a dedicated cursor-pointing motion sensor 177 and a Trackpoint device 152 that may be configured (through hardware jumpers or miniature switches or software preference settings) to serve the same function in a complementary dual use manner are present. Furthermore, the Trackpoint device 152 and/or the separate motion sensor 177 may be assigned the window scroll function which permits the contents of the active window within a windows-style operating system to be moved to the left, right, up, or down.

The Trackpoint device 152 and/or the separate motion sensor 177, may also be assigned a zoom control function which permits the contents of the active window to be zoomed in or out or magnified more or less. The flexibility of assigning specific functions to the Trackpoint pressure sensor 152, and the mouse motion sensor 177 gives the computer mouse apparatus 150 of the present invention added functionality. For example, either or both sensors may be assigned the task of rotating or moving an object in a CAD/CAM or 3D application, moving an active window or icon in a windows style operating system within the displayed area, and other tasks often accomplished via a drag-and-drop operation, a select operation, a cursor move, a mouse scroll wheel operation, or a scroll bar or slider operation.

The use of optical sensor, typically located at the bottom of a conventional mouse, may reduce mechanical components and, thus, improve the mouse's performance and reliability. A cordless mouse using RF technology has been used to reduce the intermittent failures generally associated with the wear and tear on corded or wired mouse. On the remaining surfaces, however, the buttons and wheel are still mechanical. Optical sensors and strain gauges may be used to reduce the mechanical components. Optical- or LED-based switches may be used to replace mechanical contact style switches commonly used on a computer mouse. Where the conventional mechanical mouse is used, the switch can be mounted on a flexible circuit board or one with cut sections to reduce the amount of pressure that may be applied to such buttons, thus, improving their time to failure or intermittent operation.

A control algorithm may be designed such that when a pressure is sensed at or above the threshold pressure, the switch will not move the mouse cursor until a period of time to allow the mechanical motion of the mouse to not affect the cursor placement and its associated double click. The mouse may also sense the mechanical double click from the user but it will substitute a conditioned signal in lieu of the mechanical signal of the user.

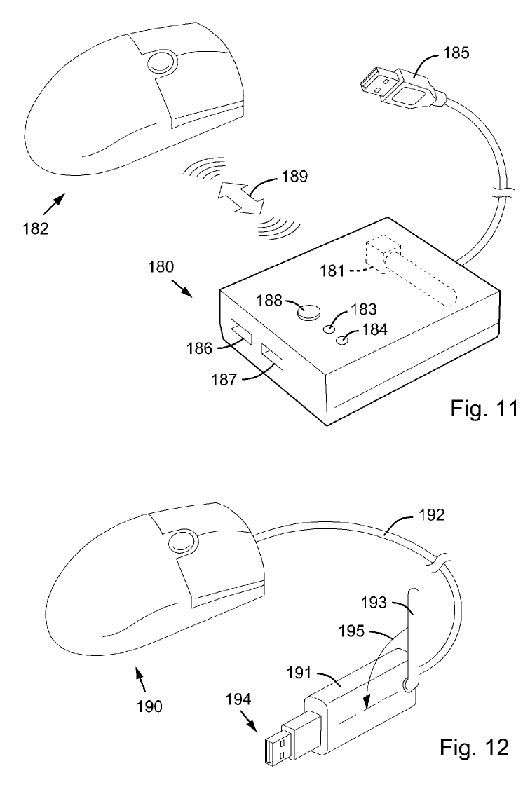

FIG. 11 is a variation of the computer mouse apparatus as illustrated in FIG. 8.

FIG. 11 illustrates a perspective view of a wireless computer mouse apparatus 182 with a Trackpoint device 152 and a companion wired base unit 180 with an embedded wireless communications adapter module and its internal antenna 181. The base unit 180 is connected to the host PC via a suitable connector such as a USB connector 185.

A connect button 188 on the base unit 180 serves to reset wireless communications to the wireless mouse 182. LED indicators 183,184 show status information and reception and transmission of wireless data. Extra serial bus ports such as USB 2.0 port 186, and FireWire port 187 permit other devices such as flash Memory devices to be connected to the host PC via the base unit 180 and its built-in USB hub/bridge.

The shared USB wired connection 158 permits a Wi-Fi, 3G, GSM, or Bluetooth, wireless adapter to be embedded within the mouse enclosure 151 (as shown in FIG. 10) rather than being installed in the host PC or connected externally to the host PC as a separate device. For the wireless computer mouse apparatus 182, the wireless adapter can be built-in into the mouse's companion base unit 180.

The wireless computer mouse apparatus 182 communicates to the wired base unit 180 using a wireless standard. The wired base unit 180 includes an embedded Wi-Fi adapter and antenna 181 and a USB hub connected to the host PC via a USB connector 185. The wireless computer mouse apparatus 182, thus, may use the same Wi-Fi standard signals to communicate mouse data to the base unit 180.

The wireless computer mouse apparatus 182 communicates motion sensor, button, and Trackpoint pressure data to the wireless adapter 181 using a suitable wireless signal (such as a Wi-Fi standard signal). The wireless computer mouse apparatus 182 may also communicate to the base unit 180 using a proprietary wireless signal. If a separate wireless standard is used for communicating the wireless data 189 from the wireless computer mouse apparatus 182 to the base unit 180, the wireless adapter 181 need not receive nor transmit the mouse specific data; rather, separate communications circuitry associated only with the mouse data component are used.

FIG. 12 is a variation of the computer mouse apparatus as illustrated in. FIG. 11.

FIG. 12 illustrates a perspective view of a wired computer mouse apparatus 190 with an embedded Trackpoint device and an in-line electronics and connection unit 191, which incorporates an integrated wireless network adapter module and its external antenna 193.

As shown in FIG. 12, the computer mouse apparatus 190 is attached to the in-line electronics and connection unit 191. The wireless network adapter is built-in into the in-line connection unit 191 and is used to establish communications using a wireless network to PCs and peripheral devices. The wireless adapter and the mouse data share a single common point of connection to the host PC. A USB connector 194 is the preferred connection means to the host PC. The external antenna 193 may be rotated 195 essentially along the connection unit 191 for better signal strength or for convenient storage.

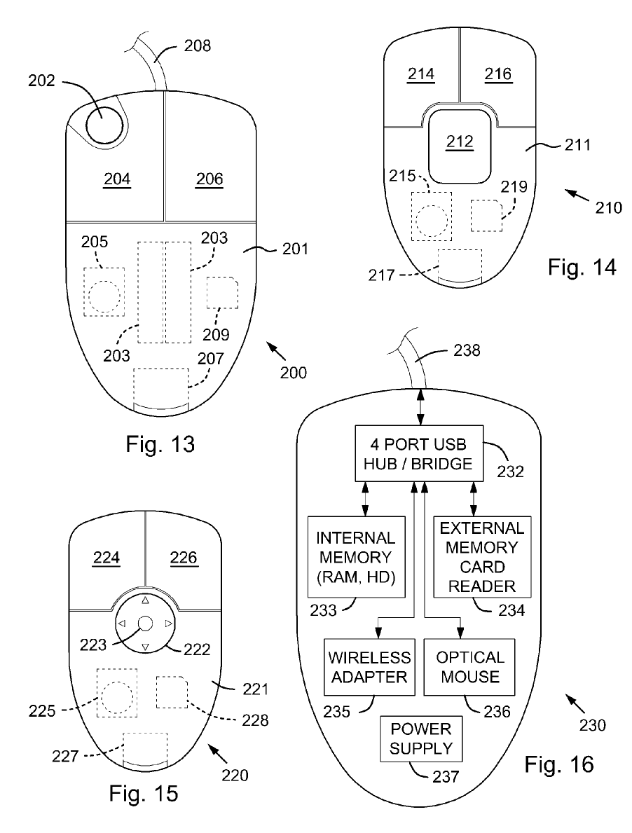

FIG. 13 is a variation of the computer mouse apparatus as illustrated in FIG. 8.

FIG. 13 illustrates a top view of a computer mouse apparatus 200 with a Trackpoint sensor 202 and an internal group of peripheral devices which include a mini hard drive 205, a wireless communications (for example, Wi-Fi standard) adapter module 203, flash (e.g. RAM, ROM) memory 209, and a flash memory card reader 207. The various embedded peripheral devices 203, 205, 207, 209 may be plug and play devices or the driver software may be stored on the embedded or removable memory within the mouse enclosure.

Also shown are a left-click button 204, a right-click button 206, a wired connection 208 to a host PC, laptop notebook, PDA, Tablet PC, or SmartPhone. The buttons 204, 206 and Trackpoint device 202 are all embedded on the mouse enclosure 201. A PC card slot or PCMCIA slot may also be incorporated into the mouse enclosure 201, thus, allowing any device which functions in a PCMCIA slot to be conveniently attached to the host PC.

The mini hard drive was introduced by IBM in the mid-1990s. Recently, the small HD devices have been further popularized by Apple Computer as used in its ipod and ipod Mini portable music players. The mini hard drives from companies like Cornice, Hitachi, Toshiba and others hold lesser data than standard hard drives. Typical capacities range from 1.5 GB to 4 GB. They are also smaller, measuring 1-2 inches across. In the second quarter of 2005, Hitachi introduced a 2.5-centimeter wide hard drive found inside some portable music devices and which can hold up to 6 GB or 6 billion bytes of data. The company appraises that a device of the same size will be able to store 60 GB using perpendicular recording. IBM has shown off a working prototype of a ultra-high density storage technology dubbed “Millipede” that could cram in the equivalent of 25 DVDs in a space no larger than a postage stamp. As with most memory devices, mini hard drive capacity is expected to increase over time. Such mini hard drives may be adapted to store data files over a USB and wireless connection.

FIG. 14 is a variation of the computer mouse apparatus as illustrated in FIG. 13.

FIG. 14 illustrates a top view of a computer mouse apparatus 210 with a TouchPad™ cursor-pointing and/or scrolling device 212 or a similar device, and internal peripherals which include a mini hard drive 215, flash memory 219, and a flash memory card reader module 217.

Also shown are a left-click button 214 and a right-click button 216. The buttons 214, 216 and Touchpad cursor-pointing and/or scrolling device 212 are all embedded within the mouse enclosure 211. The Touchpad device used in the present invention may function similarly to any generic Touchpad device available and not necessarily the Touchpad device manufactured By Synaptics.

The computer mouse apparatus 210 and its peripheral devices may communicate to the host PC, PDA, or computer device using a wired or wireless connection. Data from the mouse and the embedded peripheral devices to a single wired or wireless connection may be multiplex or may be received and transmitted according to a suitable network standard specification. When a mouse is being used in a multiplex transmission, the mouse functions may be given priority or additional resource time to increase its performance.

FIG. 15 is a variation of the computer mouse apparatus as illustrated in FIG. 8.

FIG. 15 illustrates a top view of a computer mouse apparatus 220 with a 5-Way navigation button 222. Also shown is a group of internal peripheral devices housed within the mouse enclosure 221 which includes a mini hard drive 225, flash memory 228, and a flash memory card reader module 227. There are also a left-click button 224 and a right-click button 226 embedded on the mouse enclosure 221. The computer mouse apparatus 220 and its peripheral devices may communicate to the host PC, PDA, or computer device using a wired or wireless connection.

The 5-way navigation button 222 may be used to scroll the contents of an active window, navigate menu items on a display, or serve as a cursor-pointing device. Such 4- or 5-way navigation buttons are also utilized on mobile phones, digital cameras & camcorders, and PDA devices such as a HP iPAQ Pocket PC h4350 Series. The navigation button also scrolls through lists, positions the cursor, accesses shortcuts, opens applications such as browsers, email, Instant Messenger, and lists network devices.

The 5-way navigation button 222 contains a center button 223 which functions as a select or enter key. The center button 223 may also be assigned a specific function. A range of functions may also be programmed into the buttons 224, 226, 222, 223 in a context-sensitive manner according to the program application the mouse actions are associated with.

Turning now to FIG. 16.

FIG. 16 illustrates a block diagram of a representative system architecture for the computer mouse apparatuses and their associated peripheral devices as depicted in FIGS. 8 to 15, and FIGS. 17 to 25.

Embedded within the mouse enclosure are electronics which serve the operational requirements of each embedded device such as the built-in memory (for example, flash RAM, ROM, and/or a mini hard drive) 233, the external memory card or SIM card reader 234, the computer mouse and its sensor electronics 236, and the wireless communications adapter (for example, a Wi-Fi, WiMax, 3G, GSM, GPRS, and/or Bluetooth adapter module) which serves to enable the host PC to communicate with other wireless devices and computers.

If the computer mouse is attached to a host PC or computer device via a USB connection or similar cable connection 238, a multiple port USB network hub module 232 is embedded within the mouse enclosure and serves to network the embedded devices to the host PC. The electronics and configuration of the hub/bridge device and/or the embedded peripheral devices may require modification to work optimally through the network hub/bridge module 232. Typically, standalone mouse and scanners need to be connected directly to one of the host PC's USB ports and will fail to operate if connected through a hub.

Thus, for a USB or serial connector mouse, the wireless adapter module 235 serves to provide the host PC with the capability to communicate with other wireless devices and other computers within the wireless network. The wireless adapter 235 is connected to the host PC via the internal network hub module 232. Settings for the mouse electronics and other embedded peripheral devices are adjusted through the host PC operating system and display device.

The operations of the wireless adapter module 235 and USB hub module 232 are different if the mouse is wirelessly connected to the host PC and no cable connection is present. If the computer mouse and the other embedded devices connect to the host PC or computer device using a wireless connection (for example, using a Wi-Fi, WiMax, Bluetooth, and/or a 3G standard), it is implied that some wireless capability already exists at the host PC to receive data from and to transmit data to the wireless mouse. Thus, the wireless adapter module 235 does not serve to give the host PC its basic wireless capabilities, but rather may enhance it by giving the host PC wireless capability at a different frequency band or with a different technology standard.

The primary function of the wireless adapter 235, in the case of a wireless mouse, is to enable the computer mouse data and the embedded peripheral device data to communicate wirelessly with the host PC or with other electronic devices within one or more established wireless networks.

The primary function of the USB network hub module 232, in the case of a wireless mouse, is to enable the computer mouse data and the embedded peripheral device data to communicate through the embedded wireless adapter module 235 with the host PC or other electronic devices within one or more established wireless networks. An On-The-Go USB bridge controller chip is used to give USB connectivity to embedded devices without the need for a USB connection to a host PC.

The USB On-the-Go chip such as Philips ISP1361, ISP1261, and ISP1262 enables portable devices to transfer data directly to another peripheral device without first having to connect to a PC. The USB On-the-Go spec, released in December 2001, is an addendum to the broadly implemented USB 2.0 standard. The supplemental spec allows direct connectivity between mobile handsets or portable consumer appliances without the aid of a host PC. Those conforming to the USB On-the-Go spec can dynamically set up a master-slave relationship between devices.

The power supply 237 provides a suitable voltage and current for the mouse electronics and the other peripheral electronic devices placed within the mouse enclosure. Power to the electronics may be from batteries housed within the mouse enclosure or may be supplied from the USB connector (or an equivalent connector) and its associated cable 238. If the batteries are rechargeable, they may be recharged by an AC/DC recharger unit or from the powered USB connection cable.

If the computer mouse apparatus 230 is cordless, the power supply 237 will typically include batteries housed within the mouse enclosure. In addition, power may be supplied by an AC/DC power adapter attached to a wall receptacle.

The multi-function mouse apparatus of the present invention incorporates USB host capability, for example, by utilizing an OTG bridge controller chip.

The OTG chip is incorporated in FIG. 16 and FIG. 28. The 4 Port USB Hub/Bridge 232 in FIG. 16 and the USB Hub/Bridge 351 in FIG. 28 are equivalent. Normally, the USB Hub chip and the USB OTG chip (which acts as the USB bridge) are separate pieces of hardware (e.g. the Motorola USB Hub chip and the Philips USB OTG chip). However, they are shown in the drawings as a single block 232, 351 as the two functions (hub and bridge) may be integrated into a single piece of hardware and thus, there is no need to add a block for the USB OTG chip.

Note that the USB OTG chip (if packaged separately from the USB hub chip) only adds “bridging” capabilities to the mouse. Without the USB OTG chip, the mouse will still function as a USB hub and as a Wi-Fi access point. With the USB OTG chip, the mouse can function as a “bridge”—allowing two USB peripherals to communicate and transfer data without the need for a host computer.

Each computer mouse variation shown in FIGS. 1-15 and FIGS. 17-25 may contain one or more of the following devices: a mini hard drive, embedded or removable memory, flash memory, RAM, ROM, or MRAM, a wireless communications adapter suited for operation on one or more wireless standards, a USB or network hub, a USB on-the-go bridge controller device, an encryption chip or hardware, digital signal processing devices, audio/video components and processing circuitry, modem circuitry, and one or more CPU processors and supporting chipsets. Such devices may function individually and/or in combination with the remaining embedded devices, sensors, and electronics to add to or enhance the function of the computer mouse apparatus.

An encryption chip can be embedded within the mouse enclosure to decrypt and encrypt data files, store and manage such files on external or internal memory, and permit access to a network such as the Internet via proprietary and secure protocols which may be protected by software passwords, hardware, and biometric devices.

Other devices that may be embedded within the computer mouse apparatus include various connectors such as a RS-232 Port, an on/off switch, a temperature sensor, a gas sensor such as a CO, CO2 sensor, a smoke detector, a heat detector, a pulse monitor, a barometer, an equipment Status or Parameter status display, a blood pressure monitor, a network remote control, a microphone, a speaker, a telephone modem, a cable modem, a DSL modem, an IR remote control, a telephone keypad and headset connector, an RFID tag reader, a bar code reader, a printer port, a calculator, a timer, a mobile phone, an SMS/MMS text device, a pager, a clock, a TV monitor, a battery, a battery recharger, a voice-recognition chip, an MP3 player, a digital audio recorder, an AM/FM/SW radio, and a built in 916 MHz Transceiver. A further optional peripheral devices that may be embedded within the mouse apparatus comprise a solid state compass, atomic clock, super accurate clock, Wi-Fi module, PABX indicator, pager, mobile phone SIM, SMS device, projector, and smoke detector.

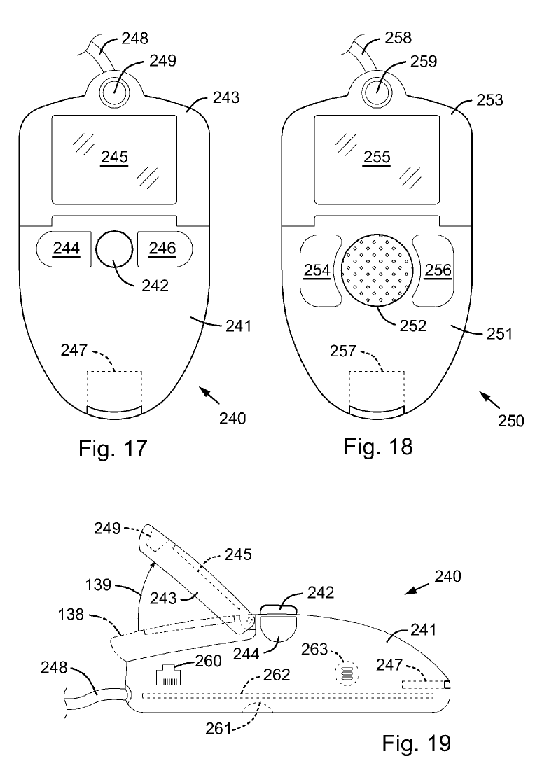

Turning now to FIGS. 17 to 25.

The computer mouse electronics and additional mouse-embedded devices (for example, the built-in memory, mini hard drives, and the wireless communications adapter depicted in FIGS. 13-16) are typically connected to and seen by the host PC as a number of distinct peripheral devices. These devices are connected to the host PC using a USB cable connection or an equivalent wired or wireless network connection. The computer mouse's embedded peripheral devices support the function of the host PC by serving as distinct peripheral devices with distinct purposes such as a computer mouse, an external memory storage device, an external hard drive, and an external wireless adapter module.

It should be understood that a CPU processor and its associated chipsets or a system-on-a-chip device may be utilized within the computer mouse apparatus. Such CPU processor or system chip may serve to manage computer processing tasks within the mouse enclosure rather than relying solely on the host PC's processing power. Thus, a mouse apparatus may run a proprietary OS, a Palm OS 3, 4 or 5, Pocket PC, SmartPhone, PalmSource, Symbian, Java, Microsoft, and Linux operating systems or any desktop O/S such as Windows XP.

In practical terms, a built-in CPU processor or system chip would enable the mouse electronics and the remaining embedded devices (for example, a mini hard drive, memory, input/output support and connectors, USB network hub or USB OTG bridge controller chip, wireless communications adapter, and the like) to function as a small self-contained computer. Such device may store and run software applications, function as a distinct unit similar to a PDA, mobile phone, MP3 player, serve as a network device providing input or output support for other devices in a network, and still provide cursor-pointing and windows scroll control for an externally connected PC, PDA, or related computer device.

Similarly, the devices depicted in FIGS. 17-25 may be configured to function as a wired or wireless network mouse (as shown in FIGS. 53-54). The mouse or keyboard can have a network connection and can therefore access or provide input to a number of target devices connected to the network, not just the host PC. The mouse cursor will appear on whichever target device/display the mouse controls have been assigned to.

A network mouse is capable of transmitting input signals to and receiving output signals from a range of network addressable (for example, Internet Protocol devices) devices within a wired or wireless network. The selection of the network device which the mouse actions may have immediate effect upon may be selected via a menu list displayed on the built-in integrated display 245 or on the monitor display associated with the host PC or network selected device. A button (not shown in FIG. 17) on the network mouse enclosure 241 may toggle the mouse's target device between a default device such as the host PC and a second device (for example, a Server PC).

A wireless network mouse with an integrated display may use a number of wireless standards such as Bluetooth for short range networking and WiMax for wide-area networking. The display screen may, for example, display a list of target devices to which the mouse may interact within one or more wired or wireless networks. The user may select which target device in the displayed list the mouse will interact with and the buttons and display on the mouse are used to change the target to other devices on the list.

Conventional USB peripherals require a “host-peripheral” configuration wherein a computer acts as the host and USB peripherals act as passive devices. With the advent of the USB On-The-Go (OTG) specification, products that have been traditionally peripherals only (e.g. digital cameras, digital audio players, mobile phones, etc.) now have the capability to act as host to other USB peripherals. This means that devices compliant with the USB OTG specification can act as a “communication bridge” between two USB devices, without the need for a host computer. USB OTG capabilities can be added to current USB compliant products by adding a controller chip, such as Philips' ISP1261 and ISP1262 bridge controller chips, which can either be integrated on the circuit board, or designed as an external “dongle”.

Most computers, laptops, and late model PDAs have a built-in USB host capability. The multi-function computer mouse apparatuses of FIGS. 8-15 and 17-25 may incorporate USB host capability. Such capability can be provided, for example, by utilizing an OTG bridge controller chip. With USB host capability built-in into a computer mouse 200 (as in FIG. 13), a flash memory card attached to a USB port or card reader 207 may store data to or retrieve data from the memory card utilizing the computer mouse's built-in wireless communications module 203.

Turning now to FIG. 17.

FIG. 17 illustrates a top view of a computer mouse apparatus 240 with a Trackpoint sensor 242, a small display 245, a flash memory card slot or SIM card reader 247, and a digital camera or webcam 249.

Also shown are a left-click button 244, a right-click button 246, a hinged display enclosure 243, and a wired connection 248 to a host PC, PDA, or mouse-compatible device. The buttons 244, 246 and Trackpoint device 242 are all embedded on the mouse enclosure 241.

The preferred display is a small black & white or color display of the type found on mobile phones and digital cameras. The display may also be an LCD or LED multi-segment display of the type found on calculators. The display technology may be of any commercial type including OLED and e-lnk technology. The display 245 may also be a dual screen display, a transflective display, or incorporated with touch screen capability. Small 1.8 inch LCD screens are available from such companies as Samsung.

Where privacy is a concern, 3M has a screen technology that prevents the display contents from being seen from the side, thus, protecting data from the prying eyes of strangers. The 3M privacy screens may be installed over the mouse display 245 or built-in into the display itself.

A mouse with a display and webcam or a stand alone network mouse may also play a role in the intelligent home and home networks of today to control a number of devices from one convenient place. For example, computer mouse apparatus 240 may screen visitors at the front door and permit entry at the touch of a mouse button. The computer mouse apparatus 240 may also select home entertainment options from items and menus displayed on home TV monitors or on the mouse's own embedded display 245.

The display 245 may be used in association with the digital camera/webcam 249 on the mouse 240 to initiate or receive video conference calls. A built- in microphone and speaker 263 on mouse 240 as shown in FIG. 19 (or the use of a PC/VOIP headset connector on the PC or mouse) enables audible communication.

The computer mouse apparatus 240 may display email and inter-office communication, images, and reminders, and may also serve as a pager and alert device. Such activities may be present on the mouse display 245 and interacted with even when the host PC or its monitor display are turned off.

The computer mouse apparatus 240, with the embedded Trackpoint device 242, may be configured as a wired or wireless device. In a wired configuration, the power may be supplied via the wired connection 248 or internal batteries. In a wireless configuration, the power may be supplied via an AC/DC adapter or by internal batteries. In a wired configuration, any wireless communications adapter may serve to add wireless capability to the host PC or a network device. In a wireless configuration, the wireless communications adapter serves to use this capability to enable the devices embedded within the mouse enclosure 241 such as the mouse electronics and the built-in memory storage devices to communicate with and support the host PC or a network device.

The computer mouse apparatus 240 may also contain any one or more of the following embedded devices: RAM memory, ROM memory, a mini hard drive, a wireless communications adapter, a network hub or bridge, a CPU and its associated circuitry, and a power supply. The embedded devices may function as peripheral devices connected via a USB or network connection to a host PC and under the control of a host PC. With the addition of a built-in CPU and its associated circuitry within the mouse enclosure 241, the embedded devices and CPU may be integrated into an autonomous computing device with wired or wireless connectivity to other computing devices on a network.

FIG. 18 is a variation of the computer mouse apparatus as illustrated in FIG. 17.

FIG. 18 illustrates a top view of a computer mouse apparatus 250 with a Trackball cursor-pointing and/or window scrolling device 252, a display 255, a SIM card reader or flash memory card reader 257, a digital camera or webcam 259.

Also shown are a left-click button 254, a right-click button 256, a hinged display enclosure 253, and a wired connection 258 to a host PC, PDA, or mouse-compatible device. The buttons 254, 256 and Trackball device 252 are all embedded on the top of mouse enclosure 251.

When a Trackball device 252 is used in a mouse 250, the Trackball device 252 serves as the mouse's motion sensor and therefore, is used for the mouse's cursor-pointing function. When a Trackball device 252 is used, the mouse 250 position is typically held stationary as there is no motion sensor at the bottom of the mouse. However, with the added functionality present in the computer mouse 250, a bottom-mounted motion sensor may be used for the cursor-pointing function to complement the cursor-pointing function of the Trackball device 252. This variation enables the Trackball device 252 to be used in other ways such as a scroll control device to move the contents of an active window, or as a menu selection device to select an item from a list displayed on the computer mouse display 255.

The computer mouse 250 with the embedded Trackball device 252 may be configured as a wired or wireless device. In a wired configuration, the power may be supplied via the wired connection 258 or internal batteries. In a wireless configuration, the power may be supplied via an AC/DC adapter or by internal batteries. In a wired configuration, any wireless communications adapter may add wireless capability to the host PC or a network device. In a wireless configuration, the wireless communications adapter uses this wireless capability to enable the devices embedded within the mouse enclosure 251, such as the mouse electronics and the built-in memory storage devices, to communicate with and support the host PC or a network device.

The computer mouse 250 may also contain any one or more of the following embedded devices: RAM memory, ROM memory, a mini hard drive, a wireless communications adapter, a network hub or bridge, a CPU and its associated circuitry, and a power supply. The embedded devices may function as peripheral devices connected via a USB or network connection to a host PC and under the control of a host PC. With the addition of a built-in CPU and its associated circuitry within the mouse enclosure 251, the embedded devices and CPU may be integrated into an autonomous computing device with wired or wireless connectivity to other computing devices on a network.

FIG. 19 illustrates a side view of computer mouse apparatus 240 as depicted in FIG. 17 showing an integrated speaker and/or microphone element 263, a network connector 260, a printed circuit board for the mouse apparatus electronics 262, and a cursor-pointing motion sensor area 261.

Also shown are a Trackpoint device 242, a display 245, a flash memory card reader or a SIM card reader 247, a digital camera or webcam 249, a left-click button 244, and a wired connection 248 to a host PC, PDA, or computer-related device.

The display 245 is housed within a hinged display enclosure 243 which is attached to the mouse enclosure 241. The hinged display enclosure 243 is normally positioned in a horizontal manner 138, but may be rotated 139 or lifted to a somewhat vertical position to reduce overhead glare and improve the quality of the display 245 image and the webcam 249 image capture.

The built-in network connector 260 enables the computer mouse apparatus 240 to access other devices on a network and receive output data from such devices which may be displayed and interacted with on the mouse's built-in display 245. The computer mouse apparatus 240 may also interact with such network devices by sending control signals to such devices directly via the network connector 260.

The network connector 260 may be any suitable network connector such as an Ethernet-style connector or a USB connector. Additional input and output connectors may be present, for example, an IEEE 1394 FireWire or i.LINK connector, an S-Video input/output connector, a digital component video connector, a microphone input and/or a PC headset connector, and a optical audio/video input or output connector.

A built-in microphone and/or speaker 263 enables the computer mouse apparatus 240 to serve as a VOIP-enabled device to conduct or participate in audio and/or video teleconference calls and to communicate with colleagues without the use of a stand alone telephone. The microphone 263 may be disabled in instances where the user chooses to only monitor a conference call or in-house communication. Set-up and participation of such teleconference calls may be facilitated by software installed on the host PC or the computer mouse apparatus 240. The Trackpoint device 242, display 245, and webcam camera 249 may facilitate the set-up and configuration process and provide video images to all the video teleconference participants.

The computer mouse apparatus 240 may be interfaced to audio and video conferencing services and avail of Internet Protocol for company-level collaboration. It may also be used with IP or non-IP end points to connect to real time inter-office or extra-office audio, video, Instant Messenger, VOIP, and webcam conferences.

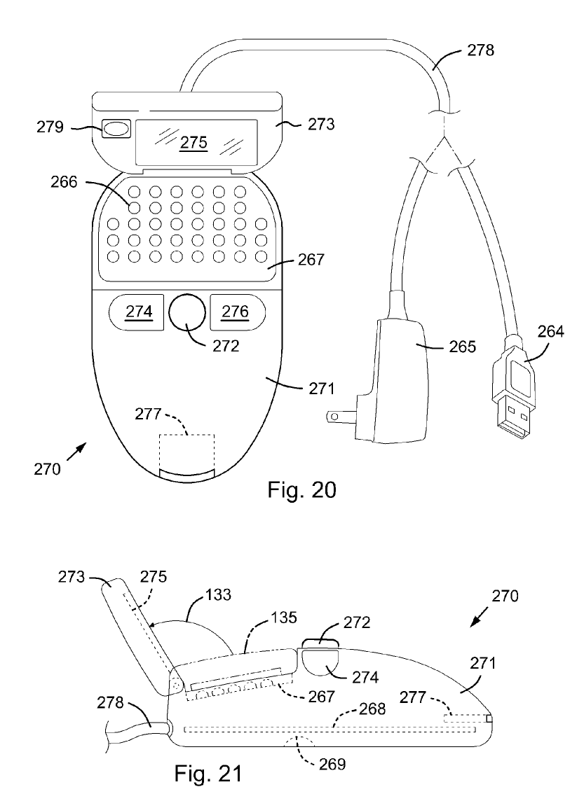

FIG. 20 is a variation of the computer mouse apparatus as illustrated in FIG. 17.

FIG. 20 illustrates a top view of a computer mouse apparatus 270 with a Trackpoint cursor-pointing and window scrolling device 272, a display 275, a flash memory card slot 277, a digital camera or webcam 279, a hinged display enclosure 273, and a number keypad or keyboard 267.

Also shown are a left-click button 274, a right-click button 276, a wired connection 278 to a host PC, PDA, or computer-related device, an optional AC/DC power supply or recharging unit 265, and an optional wired USB connector 264 attached to the mouse enclosure 271.

The computer mouse apparatus 270 can communicate to a PDA or mobile phone through a wired connection or a wireless connection such as Wi-Fi, WiMax, or Bluetooth using short range radio waves.

A typical key 266 on the mouse's embedded numeric keypad or keyboard 267 is of a size and shape similar to that found on mobile phones and embedded PDA keyboards. Numbers, letters, and symbols may be printed on each keyboard key 266.

A projector may also be mounted on computer mouse apparatus 270 which could be a dual or single LED projector on a thin panel or dual thin panel or projected on a wall. The projector lens may be located in front of the screen mounted adjacent the keyboard or on the keyboard itself. Ostar, the latest high-performance LED from Osram, is 50 times brighter than comparable predecessor models, small in size at 3 cm.×1 cm., has a high brightness of 120 lumens (lm), thus, it is ideally suited for use in mini projectors. The LED itself takes up only a fraction of the device's surface area, generating an extremely bright and uniform light for its size.

FIG. 21 illustrates a side view of the computer mouse apparatus 270 depicted in FIG. 20 showing a representation of an electronic printed circuit board 268, a flash memory card slot 277, an upright hinged display enclosure 273, and a motion sensor area 269 at the bottom of the mouse enclosure 271. Also shown are a left-click button 274, a Trackpoint device 272, and an optional wired connection 278 from a host PC, USB connection, or a computer-related device.

The hinged display enclosure 273 is rotated upright 133 to permit the user to view the display 275 properly and in order for the webcam 279 (as shown in FIG. 20) and keyboard 267 to be used. The hinged display enclosure 273 is folded closed 135 when the computer mouse apparatus 270 is stored or operated without the need for its display 275 or keyboard unit 267.

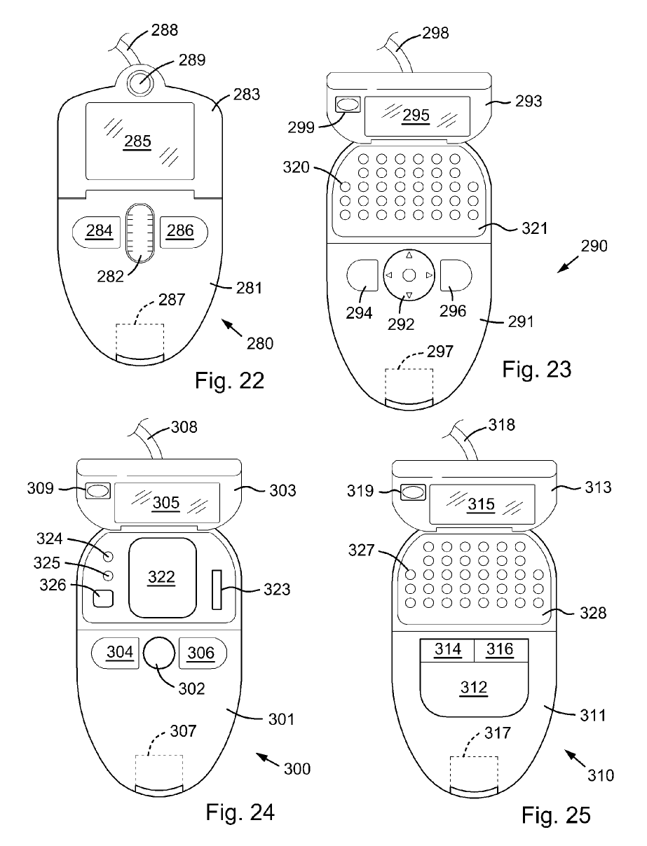

FIG. 22 is a variation of the computer mouse apparatus as illustrated in FIG. 17.

FIG. 22 illustrates a top view of a computer mouse apparatus 280 with a mouse scroll wheel 282, a display 285, a memory card slot 287, and a digital camera or webcam 289.

Also shown are a left-click button 284, a right-click button 286, a hinged display enclosure 283, and a wired connection 288 to a host PC, PDA, or mouse-compatible device. The buttons 284, 286 and the mouse scroll wheel 282 are all embedded within the mouse enclosure 281.

FIG. 23 is a variation of the computer mouse apparatus as illustrated in FIG. 20.

FIG. 23 illustrates a top view of a computer mouse apparatus 290 with a 5-way navigation button 292, display 295, a flash memory card slot 297, a digital camera or webcam 299, and a numerical keypad or keyboard 321.

Also shown are a left-click button 294, a right-click button 296, a hinged display enclosure 293, and a wired connection 298 to a host PC, Pocket PC, or mouse-compatible device. The buttons 294, 296, the 5-way navigation button 292, and each keyboard key 320 are all embedded within the mouse enclosure 291.

FIG. 24 is a variation of the computer mouse apparatus as illustrated in FIG. 20.

FIG. 24 illustrates a top view of a computer mouse apparatus 300 with a Trackpoint sensor 302, a touch screen display 305, a memory card slot 307, a video camera 309, a biometric fingerprint scanner 322, and an ID chip or SIM card reader slot 323. Also shown are a left-click button 304, a right-click button 306, a hinged display enclosure 303, and a wired connection 308 to a host PC, Pocket PC, or mouse-compatible device which is embedded within the mouse enclosure 301.

The biometric fingerprint scanner 322 may be used to authenticate a user's identification to allow access to confidential information, encrypted or password-protected data files or applications stored on the host PC or on the computer mouse apparatus 300. A start scan button 326 and “pass”, “fail” status indicator lights 324, 325 enable the biometric fingerprint scanner 322 to function without the use of a GUI dialog box on the host PC or the display 305. It should be understood that other biometric scanning devices may be embedded within the mouse enclosure 301 in lieu of the representative biometric fingerprint scanner 322 shown.

The fingerprint scanner 322 embedded within the mouse enclosure 301 may also be placed on the surface of the mouse enclosure 301 to allow frequent verification of the person's fingerprint ID or similar biometrics. For example, the fingerprint scanner 322 may be positioned near the thumb, index, or middle finger resting location on the mouse enclosure 301 so files requiring such a biometric authentication may be opened conveniently in one step.

FIG. 25 is avariation of the computer mouse apparatus as illustrated in FIG. 20.

FIG. 25 illustrates a top view of a computer mouse apparatus 310 with a Touchpad cursor-pointing and/or window scrolling device 312, a display 315, a flash memory card slot 317, a webcam camera 319, and a group of keys 327 which serve as function keys, a numerical keypad, or a keyboard 328.

Also shown are a left-click button 314, a right-click button 316, a hinged display enclosure 313, and a wired connection 318 to a host PC, PDA, or mouse-compatible device. The buttons 314, 316 and Touchpad device 312 are all embedded on the mouse enclosure 311. The Touchpad 312 may also be used to input Graffiti-style characters which may be displayed on the built-in display screen 315.

A computer mouse apparatus with an embedded or removable memory device (RAM, ROM, MRAM), a memory card reader, or a mini hard drive may be connected directly to a printer to print a file, for example, a text file or PDF file, or data from the embedded or removable memory of the computer mouse apparatus. Such a connection may be wired, for example, with a USB cable, or wireless through a Bluetooth, Wi-Fi, IR connection, and the like. Where an application is necessary to facilitate the printing function, the application may be accessed on the network, host PC, or available from the memory of the computer mouse apparatus.

It should be understood that the following devices are packaged within a common mouse housing or enclosure: keyboard, the display, the hard drive, other memory (such as RAM, ROM, MRAM, and/or its equivalents), a memory card reader, the power source, the CPU and its associated chipsets and circuitry, the Wi-Fi module, the GPS receiver module, the modem module, the network connection and its associated circuitry, the RFID tag reader, the 3G module and/or any wireless or wired electronics designed to provide data bus connectivity according to any proprietary or industry standard communication specification or protocols. Such embedded devices may function in an integrated manner with features that complement and add value to the functioning of the other embedded devices within the computer mouse apparatus.

A GPS module refers to electronics circuitry designed to receive a GPS signal and communicate the processed output data to a secondary device or application within the mouse enclosure or the host PC. A GPS receiver module may be embedded within the mouse enclosure and used by a user to locate its position on a map and search for nearby companies and services.

It should also be understood that any one or more of the embedded devices may function independently of the other devices packaged within the mouse enclosure. For example, in FIG. 20, the integrated keyboard 267 within the mouse enclosure 271 may be an independently functioning keyboard device with its own input and output data stream provided by the USB bus port. It need not be associated with the embedded display 275 and hence, may function independently of such a display. In such a case, the two devices share only a common enclosure and network connection to the host PC and the host PC treats each device as a separate peripheral device without regard to their proximity.

The computer mouse apparatus is environmentally friendly as it reduces the manufacturing, packaging, and distribution costs of multiple discrete devices manufactured or sold as separate discrete devices.

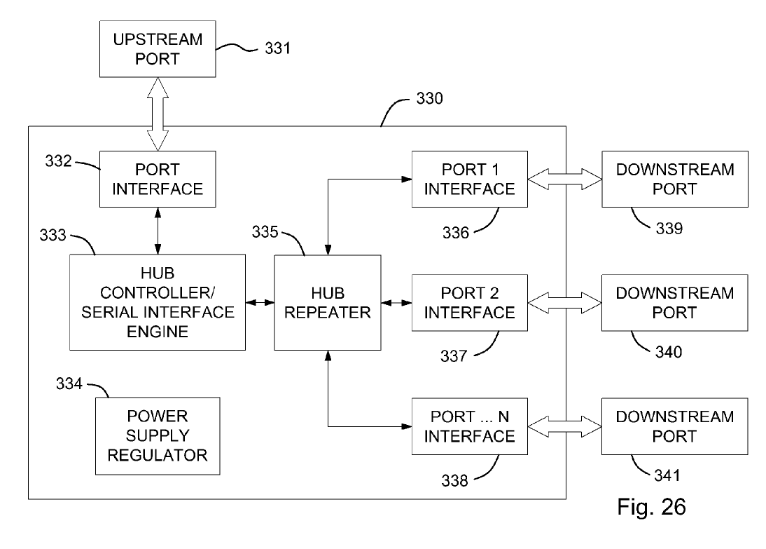

FIG. 26 is a block diagram of a simplified USB Hub 330 integrated into the computer mouse apparatus.

A USB hub 330 is essentially a “wiring concentrator” that makes possible the multiple device attachments characteristic of USB technology. USB hubs are typically implemented as a single physical chip, such as the Motorola MC141555.

A USB hub 330 consists of two core components: the hub controller 333 and the hub repeater 335. The hub controller 333 incorporates circuitry for controlling the communication between the host system (i.e. the computer) and USB peripherals or other USB hubs. The hub controller 333 also implements the serial interface engine which manages the serialization of data packets to and from the upstream port 331 and the downstream ports 339, 340, 341.

The hub repeater implements a “data switch” or “data bus” that manages the flow of data packets to and from the upstream port 331 and the downstream ports 339, 340, 341. The hub repeater typically also implements support for reset, suspend, and resume signaling.

Port interfaces 332, 336, 337, and 338 implement circuitry for interfacing with USB peripherals, USB hubs, or the host system. The power supply and regulator circuits 334 supply the chip electronics with power.

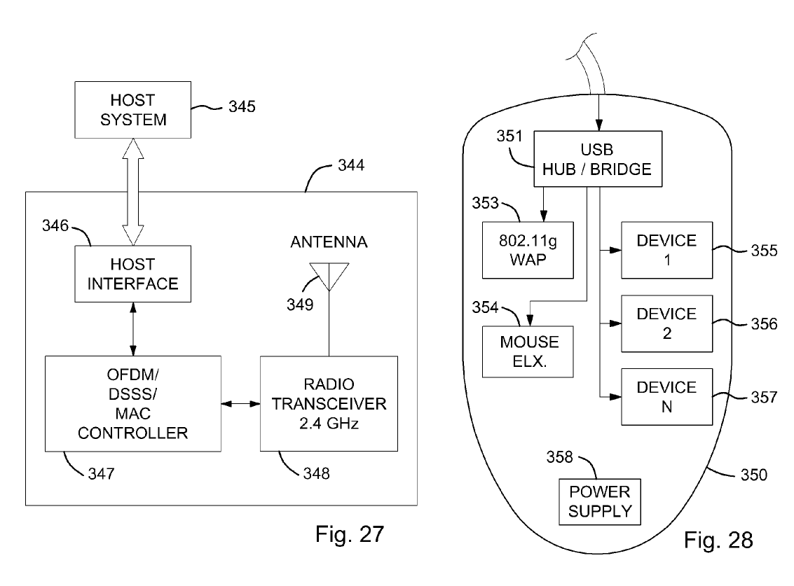

FIG. 27 shows a simplified block diagram of an 802.11 networking chipset 344. The host interface 346 implements functions that allow the chipset to interface with a host system 345 such as a computer. The host interface 346 typically uses USB, PCI, or PCMCIA technology to interface with the host system 345.

The OFDM/DSSS/MAC controller 347 is typically packaged as a single physical chip and implements the core functions of the various 802.11 versions such as 802.11g networking standard. These functions are Orthogonal Frequency Division Multiplexing (OFDM), Direct Sequence Spread Spectrum (DSSS) signal processing, and Media Access Control (MAC). In addition, encryption and Quality of Service (QoS) functions may also be implemented on the same controller chip 347 (or on a separate chip).

The radio transceiver 348 implements circuitry required for RF and other analog functions. It typically incorporates the signal amplifier, oscillator, RF filters, and frequency synthesizer.

The antenna 349 may be a directional or omni-directional Wi-Fi antenna. The antenna 349 may also be packaged as a chip antenna. An omni-directional antenna transmits a wireless signal across a 360-degree range, while a directional antenna increases the signal strength and range in a focused direction. The mouse apparatus may typically have an omni-directional antenna.

FIG. 28 shows a block diagram of a computer mouse apparatus 350 with an integrated USB OTG bridge controller and USB hub chip 351, mouse electronics 354, a wireless communications adapter 353, a portable power supply system 358, and several embedded devices such as a mini hard drive 355, integrated flash memory 356, and a flash memory card reader 357. The wireless communications adapter 353 also includes a suitable antenna(s) to transmit and receive the RF signals.

The computer mouse apparatus of the present invention incorporates USB host capability if necessary, for example, by utilizing an OTG bridge controller chip. A USB OTG bridge controller chip or chipset typically consists of the following:
(1) 1) Port interfaces, which implement circuitry for interfacing with USB peripherals. Typically, two USB peripherals will be “bridged” together by the chipset through the port interfaces. The two USB peripherals will be logically connected in a “master-slave” configuration.
(2) 2) The USB host component, which implements circuitry that allows one of the two USB peripherals to act as host. This function has traditionally been performed by a computer, because the USB host circuitry is integrated into the computer's motherboard.
(3) 3) The USB OTG controller, which contains circuitry that implements the USB OTG specifications. Typically this component contains a protocol engine which facilitates (through data translation) the exchange of data between the USB peripherals that are “bridged” together, memory for buffering data during read/write operations, as well as circuitry that allows the chip to also function as a USB peripheral.

Regardless of whether the computer mouse 350 is wired or wireless, the USB OTG chip interfaces directly to the USB Hub chip 351 and it is shown in FIG. 28 as a single block 351. The USB OTG chip utilizes the USB Hub chip because the hub chip controls the USB port interfaces on the mouse. USB peripherals that need to be “bridged” together must connect though the ports. The USB OTG chip may have its own dedicated USB ports that could remove the need to connect the USB OTG chip to a separate USB Hub chip.

It should be understood that other peripheral devices may also incorporate embedded devices which add utility beyond the basic device functionality. For example, RAM memory or a mini hard drive may be incorporated within a VOIP headset, a keyboard, a USB compatible mobile phone, a Wi-Fi or wireless communications adapter, a PC speaker system, a graphics tablet, an external display, a DSL modem, a cable modem, and the like. Data from the embedded or removable memory component of such devices may be transferred to and from the host PC, PDA, or related computer device via a wireless connection such as a Wi-Fi connection or via a wired connection such as a USB connection.

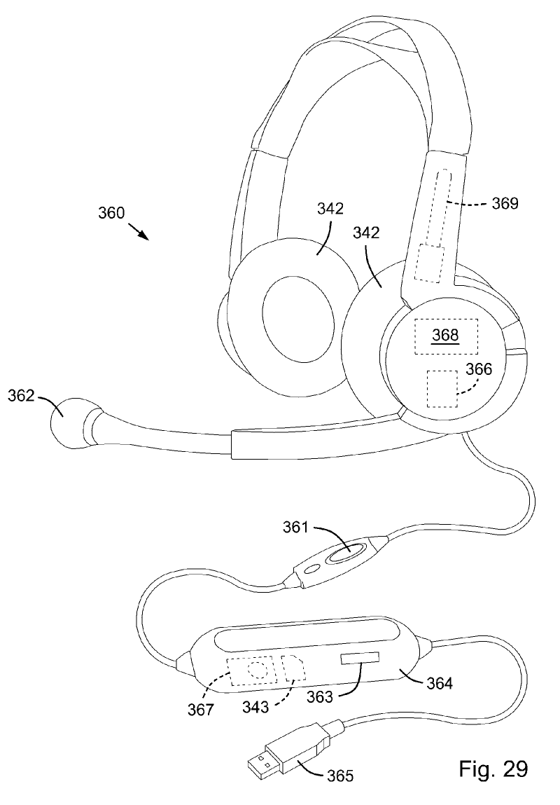

FIG. 29 illustrates a perspective view of a USB-based PC headset apparatus 360 with added functionality. It shows a wireless communications adapter and antenna 369, built-in flash memory 368, voice recognition circuitry 366 for application control and biometric authentication, a noise cancellation microphone 362, and headphone earpieces 342. The PC headset apparatus 360 plugs directly into the USB port of a host computer or device.

Also shown are in-line volume, power and mute controls 361, a USB connector 365, an in-line electronics enclosure 364 which contains a digital signal processor and circuitry 343 to digitize the analogue audio signal and send it through the USB bus to a VOIP application, a mini hard drive 367 which may serve as a digital call recorder or provide music on hold, and a flash memory card slot 363.

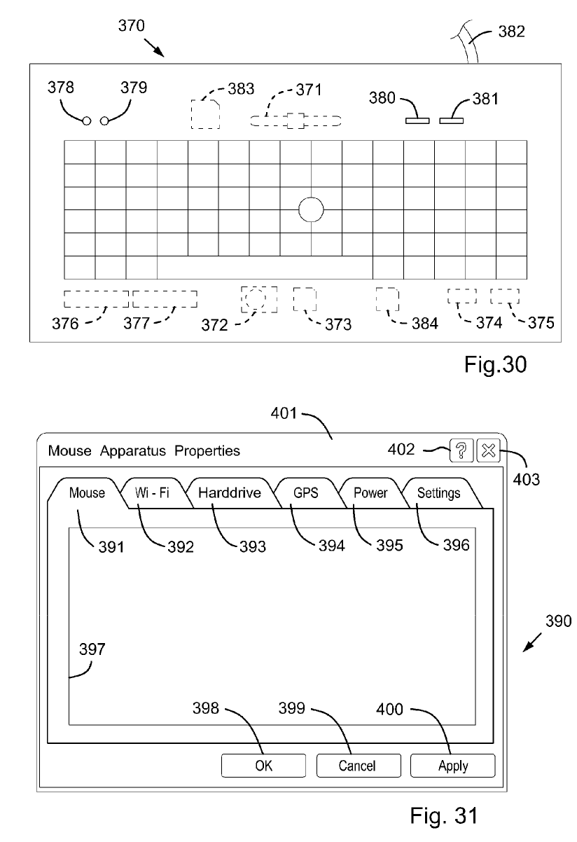

FIG. 30 illustrates a top view of a wired keyboard apparatus 370 with added functionality and its internal electronics circuitry. It shows an embedded wireless communications adapter 383 and associated antenna(s) 371, built-in flash memory 375, microphone & voice recognition circuitry 374 for application control and biometric authentication, keyboard electronics 384, a mini hard drive 372, and a USB hub and bridge controller chip 373.

Also shown are a wired connection to a host device 382, a flash memory card slot 381, an external USB or FireWire port 380, status and power LEDs 378, 379, a back-up power source 376, and a voltage regulator 377.

Thus we have seen from FIG. 29 and FIG. 30 that headsets and keyboards may also benefit from the additions of embedded devices which enhance the basic device and wireless capability to their host systems.

FIG. 31 shows a representation of a Properties Settings dialog box 390 suitable for the mouse apparatus depicted in FIGS. 8 to 15 and FIGS. 17 to 25. Each functional device embedded within the mouse apparatus 350, as shown in FIG. 28, may be controlled from a single tabbed dialog box 390.

The mouse tab 391 contains a control and settings area 397 for the mouse electronics and software similar to that found in a computer mouse in the control panel area of a typical Windows operating system. Additional tabs shown include tabs associated with the wireless adapter function 392, the mini hard drive device 393, a GPS chipset 394, power management 395, and general user settings 396.

Changes to any device settings are effected using the apply button 400. Also shown are a cancel button 399, an OK button 398, a help button 402, a dialog box title bar 401, and a dialog box close button 403.

It should be understood that upcoming technological advances may affect or may cause to replace the embedded devices of the computer mouse apparatus with future day equivalent devices, standards, and connection means, which may be similarly embedded and utilized within the mouse apparatus without departing from the spirit and scope of the present invention.

FIG. 32 is a perspective view of a computer mouse apparatus 410, its enclosure cover 412 in an open position showing a mouse cavity 415 with an integrated USB jack 414, and with USB module 406 removed and shown beside computer mouse apparatus 410.

In FIG. 32, the removable USB module 406 is shown fixedly attached to USB plug 408, and removed from the mouse cavity 415 as the bottom surface 411 of mouse cavity 415 is shown bare. A cavity is formed by the walls of the bottom surface 411 and the bottom of enclosure cover 412 when closed. Mouse cavity 415 can receive various types of modules such as USB module 406 and any USB-based device of a suitable form may be housed in mouse cavity 415, for examples: flash memory drive, Wi-Fi adapter module, GPS module, USB-connected mini hard drive, gas sensor, temperature sensor, vibration sensor, accelerometer, humidity sensor, gas and smoke sensor, keypad, touchpad, speaker, camera, network card, display, light meter, magnetic sensor, fingerprint reader, web cam, light sensor, altimeter, custom module, scientific module, USB hub, indicator module, and the like.

The various types of modules, such as USB module 406, may be fixedly attached to a USB plug 408, which in turn is slidably received by USB jack 414 as shown in FIG. 33. The modules rest on bottom surface 411 when inserted. The various module types may be manufactured in such a form that the enclosure cover 412 can be sufficiently closed and secured to the securing hook 416. A hook mechanism may be used to secure enclosure cover 412 against bottom surface 411 in the closed position. Enclosure cover 412 protects USB module 406 and can be secured by pulling down enclosure cover 412 via enclosure hinge 418 and fastened by securing hook 416. A release mechanism (not shown) is provided for manually releasing enclosure cover 412.

FIG. 33 illustrates a perspective view of a computer mouse apparatus 410, as shown in FIG. 32, but with USB module 406 connected into USB jack 414 via its associated USB plug 408.

In keeping with the present invention, USB module 406 may be integrated or built-in in the mouse cavity 415 or it could be separated from the computer mouse apparatus 410. USB module 406 rests on the bottom surface 411 as USB plug 408 (partly shown) is locked into its associated USB jack 414. Inserting a USB module 406 permits a convenient storage and allows ready access for back-ups or to store data files. For example, a flash USB module may have sufficient memory for back-up and data portability. Generally, connection to the host PC is via a common USB cable or it could be wireless, as previously described. The removable modules may have internal power supply or it may be powered externally via a USB connector.

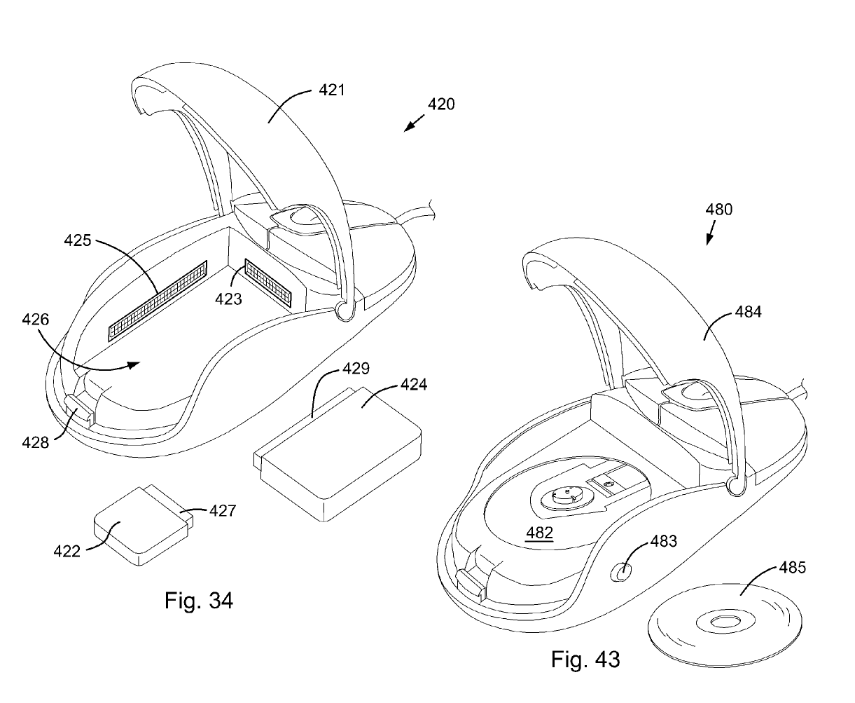

FIG. 34 illustrates a perspective view of a computer mouse apparatus 420, similar to that shown in FIGS. 32-33, its enclosure cover 421 in an open position showing module jack A 423 and module jack B 425, which are of different sizes; associated module A plug 427 and module B plug 429, which are fixedly attached to respective module A 422 and module B 424, are also shown beside computer mouse apparatus 420.

FIG. 34 is differentiated from FIGS. 32-33 in that two module jacks are built-in to the mouse cavity 426. The two module jacks slidably receive respective module A plug 427 and module B plug 429. Mouse cavity 426 may contain one or more module jacks and which can slidably receive various forms of connectors and modules, such as module A 422 and module B 424. Typically, such modules may be memory modules of various standards such as: Secure Digital (SD), mini SD, Multimedia cards (MMC), Compact Flash, Sony memory stick, and other memory module products. These removable memory modules, which are inserted singularly, are typically utilized to store and transport data in digital cameras, cell phones, music players and other consumer electronics. The modules may also be specialized modules of the type associated and enumerated in FIGS. 32-33. Enclosure cover 421 protects the modules in a closed position as the cover is secured and released via securing hook 428.

Computer mouse apparatus 420 may contain suitable interface electronics to allow the modules and connectors to share information and content access to the host PC.

FIG. 35 illustrates a perspective view of a wireless computer mouse apparatus 430 with an integrated PCMCIA slot 432, and a PCMCIA module 434 that is fixedly attached to a PCMCIA connector 435, removed and shown beside wireless computer mouse apparatus 430.

PCMCIA slot 432, as depicted in FIG. 35, may be made of sufficient height and size, and may be positioned in a way to suitably and slidably receive PCMCIA connector 435, and the fixedly attached PCMCIA module 434, from the back or rear position as shown in FIG. 36 or alternatively, from the side position alternate location of PMCIA slot 433. A suitable connector may be located within the slot cavity (not shown) which connects to the PC card slot.

PCMCIA modules perform a variety of functions and are readily available, for examples: USB 2.0 adapters, Wi-Fi adapters, 3G adapters, memory drives, flash memory sticks, GPS receivers, mini hard drives, network hubs, modems, Ethernet, and the like.

FIG. 36 illustrates a perspective view of a wireless computer mouse apparatus 430 as shown in FIG. 35, but with PCMCIA module 434 connected into the PCMCIA slot 432 via PCMCIA connector 435.

An associated internal PCMCIA jack (not shown) slidably receives PCMCIA connector 435 (shown in FIG. 35) as PCMCIA module 434 is inserted into PCMCIA slot 432. PCMCIA module 434 is fixedly attached to PCMCIA connector 435.

Wireless computer mouse apparatus 430 may also be connected to the host PC via a USB cable. If it's wired, the power supply is via the USB connector. The PCMCIA module 434 has suitable interface electronics to communicate to the host PC such as Wi-Fi or W-USB (wireless USB) connection provided that communication capability is built-in into the mouse apparatus and its associated base, and a suitable portable power supply are available.

FIG. 37 illustrates a perspective view of a wireless computer mouse apparatus 440 with an integrated USB jack 442, the latter protected by a spring-loaded cover 444; shown also is a USB module 446 that is fixedly attached to a USB plug 447, removed from and shown beside wireless computer mouse apparatus 440.

The slot formed by USB jack 442 is protected by a visible spring-loaded cover 444 to prevent entry of foreign bodies such as dust and pests, for example, when USB module 446 is removed from wireless computer mouse apparatus 440 as shown in FIG. 37. The tensioning of the spring-loaded cover 444 is accomplished by a metallic or plastic spring or by a magnet. The door may contain a compressed or stretched spring pressing one part against the other so that it is able to retract into the mouse apparatus when a module is inserted and slidably received via a USB jack.

FIG. 38 illustrates a perspective view of a wireless computer mouse apparatus 440 as shown in FIG. 37, but with USB module 446 connected into USB jack 442.

USB plug 447, which is fixedly attached to USB module 446, is inserted into and slidably received by USB jack 442, in such a fashion that spring-loaded cover 444 is moved out of the way and hinged internally. The size and height of USB jack 442 and spring-loaded cover 444 may be made to match a specific type of module; alternatively, they may be made to accommodate a variety of module sizes.

The wireless computer mouse apparatus 440 may communicate with the host PC via an integrated USB wireless adapter such that there is no need to install a separate wireless network in the host PC. USB module 446 and other USB-based devices may have an embedded or removable memory in the mouse apparatus to store, back-up, update, and synchronize data files.

FIG. 39 shows a mouse apparatus 450 incorporating a gas sensor unit 452 and its associated electronics.

Ventilation holes 454 permit airflow 453 to the gas sensor unit 452. A low vibration fan may be incorporated within the mouse enclosure to assist airflow and ventilation through the mouse apparatus 450. The ventilation holes 454 are so designed as to prevent the entry of insects or other pests into the unit. Gas sensor 452 may detect specific gases such as carbon monoxide (CO), CO2, methane, and the like. Such a mouse apparatus may find use in an industrial environment to prevent possible suffocation risk from inadvertently inhaling odorless, colorless, and flammable gases. Incorporation of gas sensor 452 within a mouse apparatus permits the user to be protected from site to site without the need for a stand alone gas detector unit. The functioning of the mouse, for example, the optical sensor, mousewheel, and buttons are unaffected by the operation of the gas sensor.

It should be understood that a smoke alarm or heat sensor with their associated electronics may also be embedded within a mouse apparatus. Such safety sensors and their associated electronics may obtain their power directly through the host PC USB cable connection or ideally, through a rechargable battery with sufficient capacity to operate for several weeks without a recharge occurring.

FIG. 40 shows a mouse apparatus 455 incorporating a dual cursor pointing device.

A Trackpoint device 456 is disposed between the right-click and left click buttons of the mouse apparatus. An optical sensor 458 (shown in hidden outline) is disposed on the bottom surface of the mouse apparatus 455. A mousewheel 457 is located on the left side of the mouse and operated with the thumb for scrolling purposes. A push button may be incorporated within the mousewheel 457 as is the convention. The mousewheel 457 may function similarly to the wheel mouse typically found in a Logitech mouse.

It should be understood, that the Trackpoint device 456 may be assigned a separate function from the optical sensor 458. For example, the Trackpoint device may be configured through the Control Panel within Windows XP to scroll the contents of a window. The use of both the Trackpoint device 456 and the optical sensor 458 as cursor pointing devices would enable the user to move the cursor great distances without lifting the mouse off the surface of the table or desk. The mouse apparatus 455 may be connected to the host PC via a wired or wireless connector. If the mouse apparatus is wired, it will typically receive power through the wired connection as is the convention.

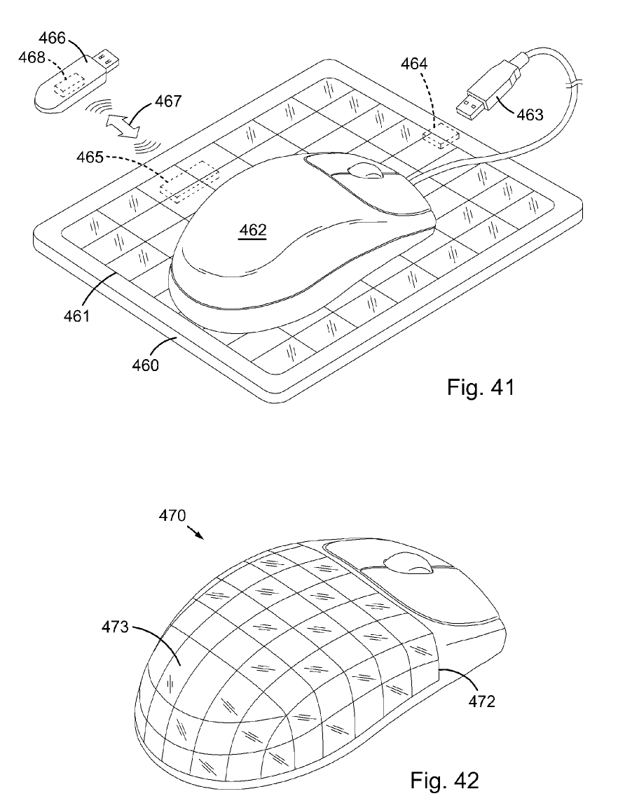

FIG. 41 shows a computer mouse apparatus 462 on the top of a companion solar panel or array of solar cells 461 disposed within a mousepad 460.

The computer mouse apparatus 462 may be a generic mouse or one specifically designed for low power use with the solar panel mousepad 460. The larger solar panel area of the mousepad 460 may provide a higher power output for continuous mouse operation than the computer mouse apparatus 470 shown in FIG. 42.

A clear transparent or translucent polycarbonate material may be used to expose the solar cells 461 to solar energy. The top enclosure material may be finely patterned to permit the mouse sensor to detect mouse movement even when the sensor is an optical sensor. Such a pattern may include a criss-cross arrangement of fine frosted lines or dots incorporated within the top polycarbonate material.

The solar energy mousepad 460 may be available in a range of functionalities. In its most basic form, the mousepad 460 contains a solar panel 461 with the necessary electronic components to serve as a power supply or battery recharger (not shown). Such a power supply or battery recharger may function to recharge other devices such as cell phones, MP3 players, and the like through a suitable connector jack or cable adapter. It is expected that the mouse will receive power from the solar panel mousepad 460 through its USB connector plug 463 which is plugged into the USB jack 464 on the side or rear of the mousepad. A specific battery charger connector may also be used to recharge the mouse batteries.

The mousepad may communicate through a wireless-USB, Bluetooth, Wi-Fi, or similar wireless connection 467 to the host PC. A wireless-USB (UWB), Bluetooth, Wi-Fi or similar wireless dongle 466 is connected to the host PC's mouse connector or USB connector to facilitate signal transfer from the mouse to the host PC with its wireless receiver chip 468. Laptops or future PCs and wireless devices may have a built-in support for wireless-USB, Bluetooth, or Wi-Fi and thus, may not require the use of a separate USB dongle 466.

The mousepad may also include electronics to serve as an external USB hub with its associated downstream USB connection ports (not shown). Similarly, for wireless networks, such as mesh networks, the solar panel mousepad and its associated circuitry 465 may serve as a connection point or relay point to extend the range of wireless devices and networks.

FIG. 42 shows a mouse apparatus 470 powered by solar energy.

Disposed within the mouse enclosure, and accessible to solar energy through a translucent or transparent enclosure cover 472, is a solar panel or array of solar cells 473. The enclosure material 472 may be of a clear polycarbonate material to permit adequate access to solar radiation. The solar panel material may be of a rigid structure or a flexible structure. The solar cells 473 may be used to supplement the power needs of the mouse device and its additional components. For example, the solar cells may be used to recharge internal batteries for wired or wireless mouse operation. A booster circuit, DC to DC converter, and/or voltage regulators may be used to stabilize the voltage and operate the mouse electronics at a suitable voltage in a variety of lighting conditions.

The solar cells for the solar cell mouse apparatus 470 of FIG. 42 and the solar cell mousepad 460 of FIG. 41 may be made of a flexible material such as H-AS solar film panel or of the more rigid but common Polymorphous silicon.

FIG. 43 shows a mouse apparatus 480 with an integrated optical drive 482 disposed within the mouse enclosure, and accessible through the enclosure cover 484.

The optical drive 482 typically reads data from a mini CD-ROM disc 485. It should be understood that optical drive 482 may also write data to a smaller version of CD-R, CD-RW, and various DVD disc formats. Push button 483 is pressed to release enclosure cover 484 to permit easy insertion and removal of the optical disc 485. The enclosure cover 484 is spring loaded and damped to gently lift it to an open position.

The optical drive 480 may be connected to a host PC or similar electronic device through a shared USB cable connection facilitated by the hub architecture of FIG. 16 or FIG. 28. The mouse and the optical drive electronics receive their power through the USB powered connection.

A smaller 1- or 2-inch form factor disc 485 is used with the optical device. The technology may be based on CD-ROM or DVD disc including the newer standards such as HD-DVD, Blu-Ray Disc, or Iomega's AO-DVD . The functionality supported allows such smaller discs to be used for data storage, video games, music, movie recording and playback, or as a boot device or for installing software programs. Optional Buttons (not shown) located internal or external of the mouse apparatus may permit the user to stop, start the device, and allow the device to play, rewind, and fast forward through presentations, music, or movie content..

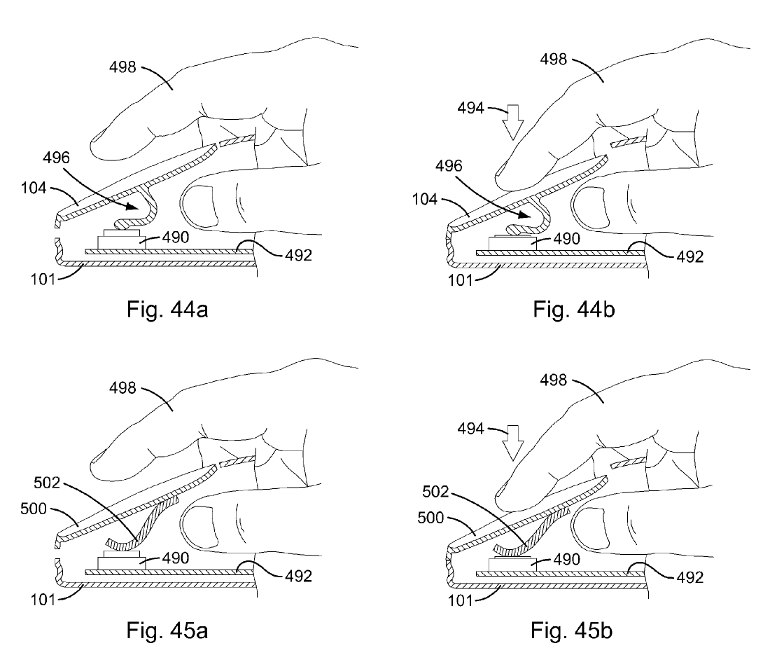

Turning now to FIGS. 44a to 46b.

It is not uncommon for a mouse apparatus and a keyboard apparatus to occasionally fail or become intermittent as a result of frequent and intense use of their associated mouse buttons and keyboard keys. This may result in putting too much stress on the miniature switch mounted on the printed circuit board (PCB) because of the continuous and heavy clicking and thus, may eventually damage the said switch. Accordingly, to prevent or minimize such an occurrence, FIGS. 44a to 44b, 57-58 incorporates several shock absorbing means to reduce and dampen stress on the miniature switch.

FIGS. 44a-44b are simplified partial cross sectional views of a computer mouse apparatus taken along lines 44-44 of FIG. 1 showing a molded pressure absorbing spring 496, which functions to reduce the stress on a miniature switch 490 caused, for example, by frequent heavy clicking of a user.

In FIG. 44a the hand and the finger 498 of the user are shown in a disengaged position. Molded pressure absorbing spring 496 is integrated into the bottom of mouse button 104 (such as a left-click button) and rested on a miniature push button switch or microswitch 490. Also shown are printed circuit board (PCB) 492 where the switch 490 is mounted, and portion of mouse enclosure 101.

FIG. 44b shows a hand and finger 498 in an engaged position as the tip of finger 498 presses on mouse button 104, as indicated by finger pressure direction arrow 494. The stress caused by the continuous pressing down of mouse button 104 is borne by the molded pressure absorbing spring 496. However, there is still enough force transmitted to the spring 496 such that to actuate miniature push button switch 490.

FIGS. 45a-45b illustrate a fixedly pressure absorbing leaf spring 502, a variation of the spring design as shown in FIGS. 44a-44b.

FIG. 45a shows a hand and finger 498 of the user in a disengaged position. The fixedly attached pressure absorbing leaf spring 502 is fixedly attached to the bottom of mouse button 500 as it rests on miniature push button switch 490. The spring 502 may be of different material from the mouse button 500 as it could be metallic or plastic and ultrasonically welded. Just as in FIGS. 44a-44b, the fixedly attached pressure absorbing spring 502 also functions to reduce the stress caused, for example, by frequent heavy clicking of a user.

FIG. 45b shows a hand and finger 498 in an engaged position as the tip of finger 498 presses on mouse button 104, as indicated by finger pressure direction arrow 494. As the leaf spring 502 bears the stress caused by a continuous pressing down of mouse button 500, the leaf spring 502 still transmits enough force to actuate the switch 490.

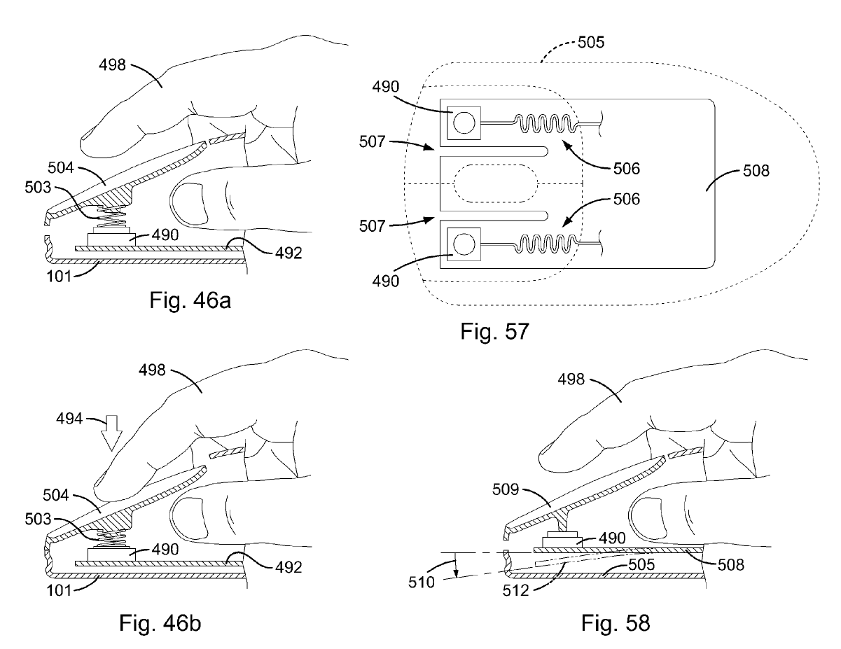

FIGS. 46a-46b illustrate a pressure absorbing compression spring 503, a further variation of the spring designs as shown in FIGS. 44a-45b.

The hand and finger 498 of the user are shown in a disengaged position in FIG. 46a with a pressure absorbing compression spring 503 in a rested position. The spring 503 may also utilize a traditional spring that may be compressed or stretched pressing one part against another to take in stress when finger 498 pushes down mouse button 504.

FIG. 46b shows a hand and finger 498 in an engaged position as the tip of finger 498 pushes down on mouse button 504 and flattens the compression spring 503, as indicated by finger pressure direction arrow 494. The stress caused by the continuous pressing down of mouse button 504 is borne by the compressed spring 503. However, there is still enough force transmitted to the spring 503 such that to actuate miniature push button switch 490.

It should be understood that the various spring designs illustrated in FIGS. 44a-46b can limit or reduce the amount of force applied to switch 490 and printed circuit board (PCB) 492 when the mouse button is pushed down continuously but the various spring designs can still apply enough force to easily actuate the switch 490.

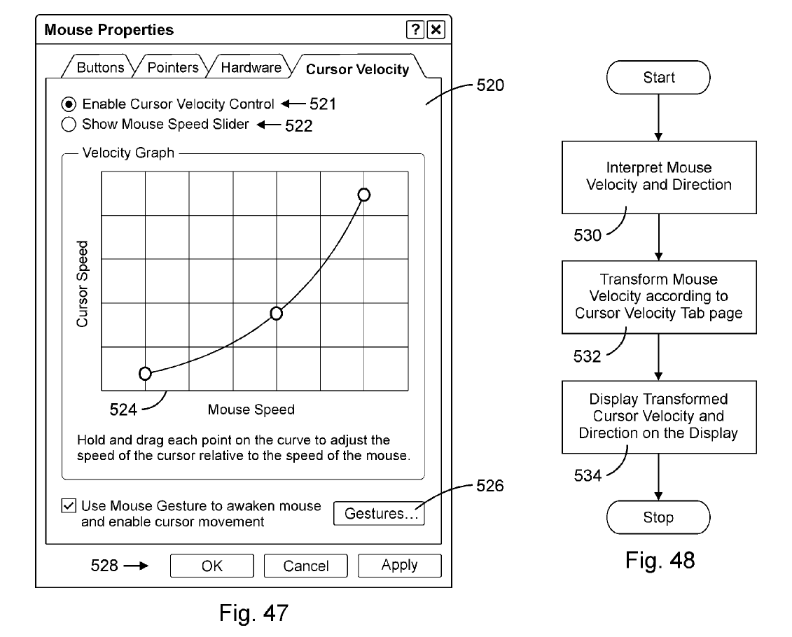

FIG. 47 shows a cursor velocity tabpage 520, which is used to control the relationship between the velocity of the mouse movement and the velocity of the displayed cursor associated with the mouse movement.

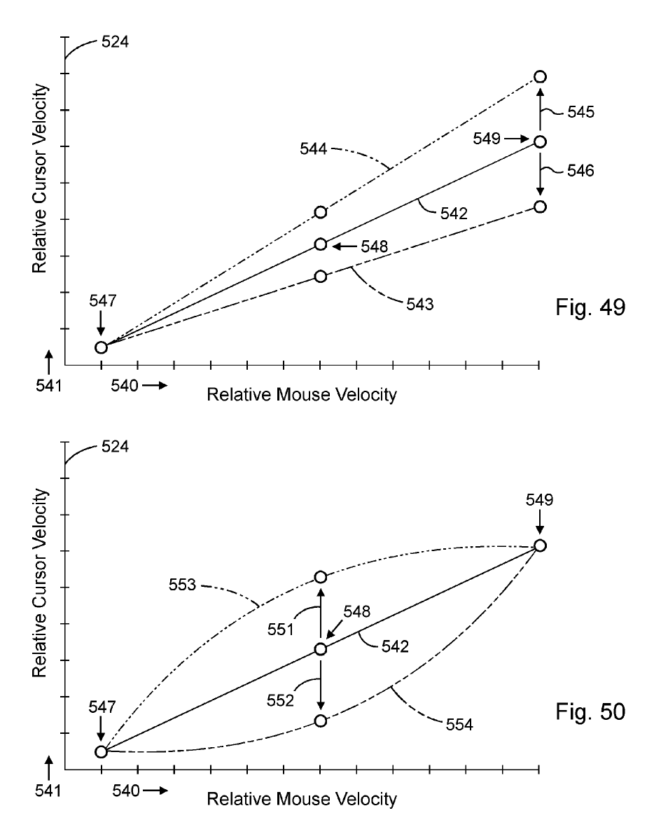

Shown in tab page 520 is a two-dimensional graph 524 which maps the mouse's physical velocity (shown on the X axis 540 of FIGS. 49-50) to the displayed cursor velocity (shown on the Y axis 541 of FIGS. 49-50). The function of the graph and its control points is explained in more detail in FIGS. 49-50.

A mouse gestures settings button 526 is also indicated. Specific mouse gestures may be used to enable the display cursor if the mouse has been inactive for some time. Examples of mouse gestures include circular clockwise or counter-clockwise movements, zigzag movements, and sideways movements. This is helpful in environments where there is vibration or accidental movements of the mouse, and the user does not wish this accidental movements to move the display cursor.

The two-dimensional velocity graph is shown when radio button 521 is selected. If radio button 522 is selected, a more conventional one-dimensional slider velocity control appears (not shown). Any change to the settings of the cursor velocity tabpage 520 is effected by pressing the option buttons 528.

FIG. 48 shows a simple flowchart process to control cursor velocity.

With each movement of the mouse, the optical, laser, or mechanical sensor that are associated with the mouse, measure the displacement of the motion sensor and make this data available to the host or target device. The software under the control of the host or target device interprets the mouse displacement, for example, the motion's velocity and direction 530, and prepares to map this information to the display cursor 532 according to the settings of the cursor velocity tabpage. The mouse displacement data is then displayed as a cursor movement with a specific direction and an adjusted cursor velocity 534.

FIGS. 49-50 show in detail the operation of the two-dimensional graph 524 of FIG. 47. The graph 524 permits the user to adjust how the speed of the physical mouse maps to the speed of the mouse cursor on the display device. A line or curve 542 is shown on the graph 524 as are curve control points 547, 548, 549, each of which may be held and dragged up or down as indicated by direction arrows 545, 546, 551, 552 to change the shape of the curve 542 to 544, 543, 553, or 554 respectively. The function of the curve control points 547, 548, 549 are similar to the function of the curve control points in the Duotone Curve dialog box available in Adobe Photoshop CS.

The default straight line shape shown in FIG. 49 is consistent with the speed control function of a mouse available using the control panel in Windows XP. Two alternative curve shapes 553, 554, are shown in FIG. 50. In the top curve 553, a slow mouse speed results in exaggerated cursor speed movements in the same direction. Further increases in mouse speed results in a diminishing cursor speed response. In the bottom curve 554, slow mouse speed results in slower cursor speed movements in the same direction. Further increasing mouse speed results in more exaggerated cursor speed response. Thus the user can customize cursor speed response as a function of various mouse speeds.

The curve 542 shape may be constrained to prevent a negative slope in the curve 542 as this may confuse some users of the velocity control graph 524. Similarly, the left most point 547 of the curve 542 should not cross the Y axis 541 (the relative cursor velocity axis). Otherwise, it would imply the cursor should move when the mouse is stationary and there is no mouse velocity.

The left most point 547 may however, be placed on the X axis 540 (the relative mouse velocity axis) to imply that there is a certain threshold velocity necessary with the mouse in order for the display cursor to respond to the mouse movement. Although the controls in FIGS. 47, 49-50 are shown for a 2D mouse speed adjustment, it should be understood, that the same graph technique may be used to control mouse speed to display cursor velocity in a 3D environment. Similarly, although the control is directed towards cursor velocity, it will be available when a 2D or 3D object is moved in a program or game. Such a cursor velocity control may also be adapted for use with a Trackpoint™ device, a Trackball™ device, or a Touchpad™ device.

The following discussions are intended to provide a brief, general description of the computer apparatus architecture. Accordingly,

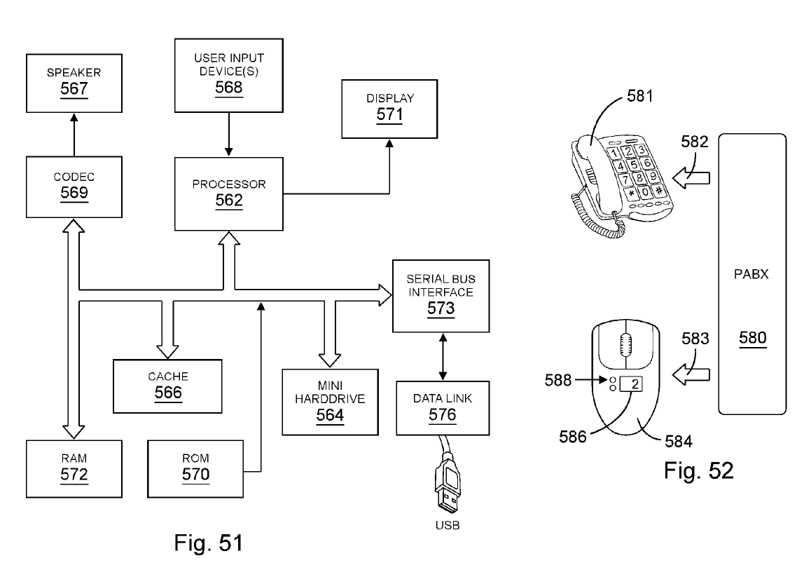

FIG. 51 shows a computer apparatus architecture typically associated with the mouse apparatus of FIGS. 17-25 in accordance with an embodiment of the present invention.

The mouse apparatus architecture, permits the mouse to act as a network device in any wired or wireless network or USB connections. The computer mouse apparatus of FIG. 51 includes a processor 562 that pertains to a microprocessor or controller for controlling the overall operation of the mouse apparatus; this processor 562 is typically a low power consumption processor, or a system-on-a-chip design. The mouse apparatus stores different kinds of data such as audio, media, documents, and the like in a mini hard drive 564, cache 566, or RAM 572. The mini hard drive 564 is, typically, a small storage disk fitting within the form factor of a mouse apparatus. The mini hard drive 564 typically provides a data storage capability for the mouse apparatus and a back-up storage for other devices. However, since the access time to the mini hard drive 564 is relatively slow, the mouse apparatus may also include cache memory 566. The relative access time to the cache 566 is substantially shorter than for the mini hard drive 564. However, the cache 566 does not have the large storage capacity of the mini hard drive 564. Furthermore, the mini hard drive 564, when active, consumes more power than does the cache 566. The power consumption is particularly important when the mouse apparatus is a stand alone mouse that is powered by a battery (not shown). The mouse apparatus also includes random-access memory (RAM) 572, and read-only memory (ROM) 570. The ROM 570 can store programs, utilities or processes to be executed in a non-volatile manner. The RAM 572 provides volatile data storage, such as for the cache 566.

The mouse apparatus also includes a number of user input device(s) 568 such as a mousewheel, keypad, left-click and right-click buttons, touchpad input, Trackpoint device, and the like that allows a user to interact with the mouse apparatus.

Still further, the mouse apparatus includes a display 571 (for example an LCD display) that can be controlled by the processor 562 to display the output and information to the user. A system bus 578 facilitates data transfer between at least mini hard drive 564, cache 566, processor 562, and CODEC 569. The mouse apparatus also includes a serial bus interface 573 that couples to a data link 576 (for example, a USB connection). The data link 576 allows the mouse apparatus to couple to a host device and the mouse apparatus will be submissive to that host device and if the mouse apparatus detects that there are no host devices nearby the mouse apparatus may serve as the host device itself. The audio CODEC 569 produces analog output signals for a speaker 567. The speaker 567 can be a speaker internal or external to the mouse apparatus.

FIG. 52 shows one use of a mouse apparatus with added functionality.

A PABX branch exchange telephone system 580 is shown in an office environment setting. Incoming calls are routed to an extension telephone unit 581 through a wired connection 582. However, if the recipient of the call is not present in their office (or does not wish to be disturbed), a message waiting indicator 586 or voicemail waiting indicator may be shown on the mouse apparatus 584. Messages can be transmitted to the mouse using a wired or wireless connection 583. The mouse apparatus may have additional buttons and lamps 588 to cancel or scroll through call data or to reset the indicator display.

With the added functionality and processing capability of the mouse, keyboard, and PC headset apparatus depicted herein, it is desirable to network or assign the apparatus output to a specific device through a wired or wireless connection. Accordingly,

FIGS. 53a and 53b show a partial view of a network mouse apparatus 590 assigned to input data to a specific device.

The network mouse apparatus 590 may be connected to a network device, a host PC, or a peripheral device using a suitable wired connector or wireless communications standard such as Wi-Fi. The network mouse apparatus 590 includes a power supply, a right-click button and left click button 595, a mousewheel 594 with its associated button (located beneath the mousewheel and not shown), an optical sensor (not shown) located at the bottom on the network mouse apparatus 590 for providing mouse displacement information, and an LCD display 592 or low power display accessible to the user with a form factor suitable for use on a mouse apparatus. Electronics circuitry to support the mouse function and electronics and software to permit the network mouse apparatus 590 to interface with suitably configured network devices such as PCs and servers are self-contained within the mouse enclosure.

In FIG. 53a, the network mouse apparatus 590 is assigned to PC1 as indicated in display 592 by direction arrow 596. To change the target device for the mouse's displacement data, the user accesses the change target function of the network mouse (not shown) and using the mousewheel 594, scrolls down to the next target device, for example, PC2 as indicated in FIG. 53b by direction arrow 597. To change the target device, the user has only to enter the new device on the mouse using a left-click on button 595. After the target device for the network mouse is changed from PC1 to PC2, the mouse movement or displacement data from the network mouse apparatus moves the cursor display associated with PC2, not PC1.

It should be understood, that a network keyboard apparatus may also be assigned to input data to a specific device either on a network or through a direct connection. Similarly, both the network mouse apparatus and the network keyboard apparatus may be assigned to a single target device simultaneously for convenient, fast access.

The display 592 of the network mouse apparatus 590 may show a list of target devices accessible or assignable to the network mouse's data output including its displacement data output. As detailed in FIG. 53, the mouse display 592 enables the network mouse apparatus to access key functions within a target device such as to move the cursor associated with the target device, or to control various functions on the device through the interface or GUI menu displayed.

FIG. 54 illustrates a typical operating environment for a network mouse apparatus 601, 602.

Network mouse apparatus 601 is a wireless device, such as a wireless-USB device, while network mouse apparatus 602 has a wired connection to a network or a second device. Other devices on the representative network 600 include PC 603, server PC 604, printer 608, laptop PC 607, optical or magnetic storage device 606, and a TV or LCD display 605.

A network mouse apparatus may connect to different devices directly, or via a network connection. Such connections may be enabled through a variety of wired or wireless standards and protocols such as USB, Ethernet ports, Wi-Fi, Bluetooth, wireless-USB, and the like.

Administrative permissions may be required to enable a device to accept input or displacement data from the network mouse apparatus 601, 602, either through a direct connection or through a network connection, be it wired or wireless. Such administrative access settings, permissions, and security restrictions or firewalls are typically on the target device side but may also be implemented on the network mouse apparatus. For example, the mouse may have the ability to exercise administrative control over one or more devices on a wired or wireless network. The network mouse apparatus and the target device to which it directs its displacement data will have the necessary software, hardware, and drivers to communicate and exchange data in a seamless but secure environment once configured.

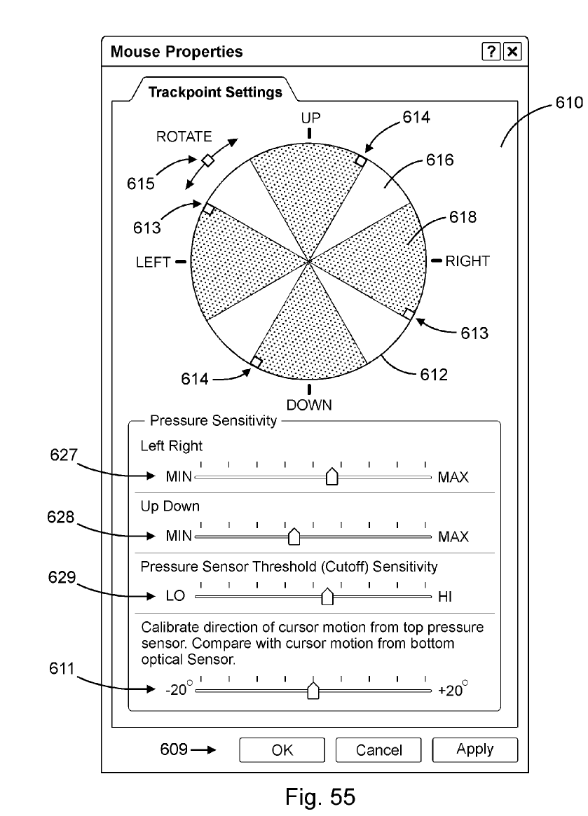

FIG. 55 shows a Trackpoint settings tabpage 610 associated with a Trackpoint device if present on a mouse apparatus, for example, mouse apparatus 455 of FIG. 40.

The Trackpoint device possesses properties and characteristics that are different from the optical sensor typically located at the bottom of the mouse apparatus 455 of FIG. 40. Thus, both the optical sensor and the Trackpoint device need to be calibrated separately and with respect to each other. For example, the pressure exerted by the index finger on the Trackpoint device may make the display cursor skew in a direction different from that of the optical sensor. Control 611 permits the user to rotate the Trackpoint device cursor direction relative to the optical sensor so that both sensors move the displayed cursor in a similar intended direction for a specific user.

Similarly, there are Trackpoint pressure sensitivity controls 627, 628 for the left-right and up-down pressure, respectively, exerted on the Trackpoint device by the index finger of the user. A threshold pressure level may be set with control 629 which will not move the display cursor if the pressure is below such a threshold. This control 629 is especially useful if the user rests his or her finger on the trackpoint device during normal mouse operation.

The Trackpoint device controls may also be effected graphically using the circular graphical control 612. For example, control 615 will rotate the direction of the displayed cursor travel when pressure is applied to the Trackpoint device. The square control point is held and dragged with a cursor similar to the circular control points shown in FIGS. 49-50. The user should notice the changes to their cursor characteristics in essentially real time. Changes to any settings are effected by pressing button 609.

Similarly, square control points 613 adjust the direction angle of pressure exerted on the Trackpoint device that results in a left-right scroll operation. Square control points 614 adjust the direction angle of pressure exerted on the Trackpoint device that results in a up-down scroll operation. As square control points 613, 614 are held and dragged, the angle shown graphically by the dotted pattern 618 expands or contracts for the respective square control point. The empty space 616, if present, will result in a no scroll action if pressure is exerting on the Trackpoint device in such a direction.

It should be noted that a generic strain gauge with its associated control algorithm may be used in lieu of the Trackpoint device and similar generic substitutions may be made in relation to the Touchpad device and other branded and trademarked devices.

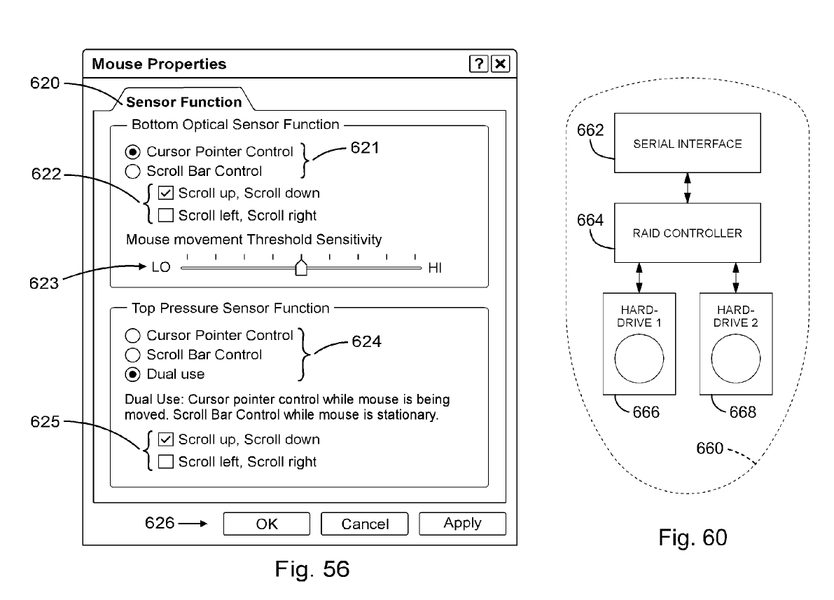

FIG. 56 illustrates a sensor function tabpage 620.

The sensor function tabpage 620 assigns the function of each of the dual sensors on the mouse apparatus. For example, the bottom optical sensor, when displaced, may function to scroll a window's contents or as a cursor pointing device. Such setting are made with radio buttons 621. Checkboxes 622, 625 permit the scroll bar movement to be limited to the up-down or left-right direction if desired. A threshold level sensitivity control 623 may be used to limit cursor movement if vibration is present such as in an industrial setting or when traveling. The top pressure sensor or Trackpoint™ device, for example, as depicted in FIG. 40, may be used as an additional cursor pointing device, a scroll bar control or both depending on whether the bottom cursor is detecting movement or a stationary mouse. Such setting are made with radio buttons 624. Changes to any settings are effected by pressing buttons 626.

FIG. 57 illustrates a top view of a cantilevered printed circuit board (PCB) 508 which serves as a pressure absorbing means, a variation of the pressure absorbing spring designs as shown in FIGS. 44a-46b.

The cantilevered printed circuit board (PCB) 508 is partly mounted to the bottom of mouse enclosure 505 with two cut-out portion 507 to separate the two mouse buttons. Also shown are two copper wire conductor 506, each one composed of two wires or conductors that serve as contact points. The wires are somewhat curved to reduce stress and cracking the wire when the printed circuit board (PCB) 508 is bent as a result of pushing down mouse button 509.

FIG. 58 is a cross sectional view of the mouse apparatus shown in FIG. 57 and a variation of the cross sectional views of FIGS. 44a-46b.

In FIG. 58, a hand and finger 498 are shown in a disengaged position as mouse button 509 rests on miniature push button switch or microswitch 490. The cantilevered printed circuit board (PCB) 508 flexes when pressure is applied on mouse button 509, for example, during continuous clicking by a user. The flexing action of the cantilevered PCB 508 reduces the amount of stress exerted to the switch 490 as the cantilevered PCB 508 moves down to its PCB flex position 512 as indicated by flexing direction arrow 510. As the cantilevered PCB 508 reduces the force applied to the switch 490, there is still enough force applied to easily actuate switch 490.

FIGS. 59a and 59b show bottom views of a mouse apparatus 650 with a built-in charger unit and a retractable wall plug 654 at its bottom.

The wall plug 654 is housed in a wall plug cavity 652 located at the bottom of the mouse unit near the mouse displacement sensor 658 (typically an optical sensor). The wall plug's metallic prongs 656 are normally recessed within the mouse enclosure 650 and wall plug cavity 652 and do not touch the surface on which the mouse operates. When the unit requires charging, an indicator light (not shown) on the top surface of the mouse apparatus may indicate a low power condition. The mouse apparatus is charged by rotating the wall plug 654 essentially 90 degrees outward and pushing the wall plug's metallic prongs 656 into a power receptacle. Once fully charged, the mouse apparatus may be removed from the power receptacle and the wall plug retracted to its original stored position. An indicator lamp may indicate a fully charged condition. It should be understood that the mouse apparatus and its internal rechargeable batteries may be charged over a range of voltages, for example, from 110-220 volts, and may also be used to operate some of the devices on the mouse apparatus with relatively higher power consumption.

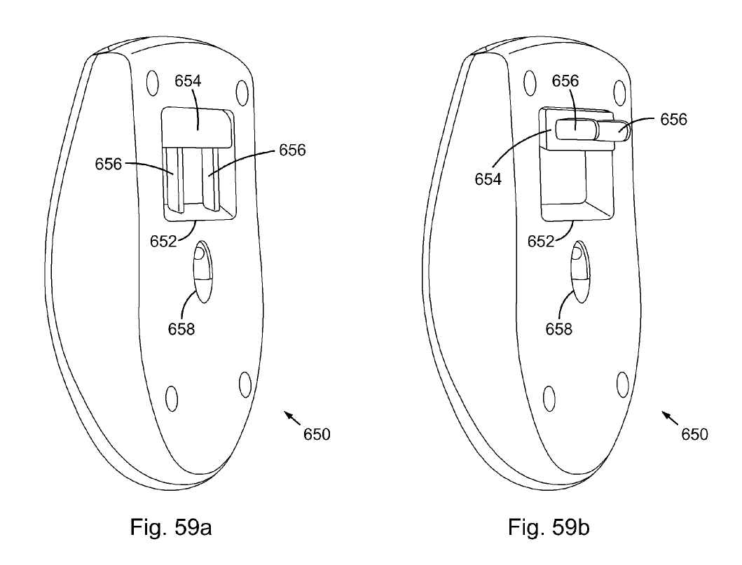

FIG. 60 shows a mouse apparatus architecture when the additional device is in a RAID system of mini hard drives.

A redundant array of independent (or inexpensive) disks (RAID) system components include at least two hard drives 666, 668 within the mouse apparatus enclosure 660. The hard drives 666, 668 are typically mini hard drives with performance suitable for use within a RAID system for faster read/write times or mirroring of data to both hard drives. The hard drives 666, 668 are connected to the controller chip 664 which interfaces with the serial interface 662 to connect ultimately with the target device or host PC. The mouse architecture (not shown) also interfaces with the serial interface to share a common path to the target device or host PC.

It should be understood that with the rapid developments of wireless device technology, each device may have an independent wireless path or channel to the target device or host. In this arrangement, the bandwidth need not have to be shared among all the devices. For example, the mouse specific data may be communicated via a USB cable which also supplies power to all devices within the mouse enclosure 660. However, the RAID data may be received and transmitted wirelessly using a wireless adapter (not shown) integrated within the enclosure.

When multiple devices are networked or share a common wired or wireless bus connection, the mouse specific functions, within the mouse apparatus, may be given priority or additional bandwidth when the mouse is being used to increase its performance. When a mouse is used on a desktop PC, it is often connected directly to a USB port rather than through a hub to improve performance.

As will be apparent to those skilled in the art, the present invention may be embodied in other specific forms and variations without departing from the essential characteristics and true spirit thereof. Accordingly, the foregoing description is intended to be illustrative, but not limiting. The intended scope of the invention may thus include other embodiments that do not differ from the literal language of the claims. The scope of the present invention is accordingly defined as set forth in the following claims.

What is claimed is:

1. A computer mouse apparatus comprising an enclosure, a displacement sensor, at least one button, electronics associated with the function of the displacement sensor, a wired or wireless connection to a host device, a hub device disposed within said enclosure, and at least one additional device disposed within said enclosure; wherein said additional device communicates with said host device through said hub device.

2. The computer mouse apparatus of claim 1 wherein said additional device is chosen from the group consisting of: a Trackpoint™ device, a strain-gauge device, a display device, a wireless adapter device, a GPS receiver module, a gas sensor device, a smoke alarm device, a flash memory card reader device, a flash memory storage device, a mini hard drive, and combinations thereof.
